(19) United States
(12) Patent Application Publication
(10) Pub. No.: US 2024/0279981 A1
(43) Pub. Date: Aug. 22, 2024

(54) HOME APPLIANCE

(71) Applicant: LG Electronics Inc., Seoul (KR)

(72) Inventors: Dongkwan YU, Seoul (KR); Eunseo CHOE, Seoul (KR)

(73) Assignee: LG Electronics Inc., Seoul (KR)

(21) Appl. No.: 18/444,076

(22) Filed: Feb. 16, 2024

(30) Foreign Application Priority Data
Feb. 17, 2023 (KR) 10-2023-0021763
Dec. 4, 2023 (KR) 10-2023-0173655

(51) Int. Cl. E06B 3/72; E06B 3/36

(52) U.S. Cl. CPC E06B 3/72; E06B 3/36

(57) ABSTRACT

A home appliance includes a body having an inner space defined therein and a door configured to open and close the inner space. The door includes a door frame located in front of the body and a door panel located in front of the door frame. The door panel includes a panel body located in front of the door frame to cover the door frame, a fitting protrusion fitted with the door frame to couple the panel body to the door frame, the fitting protrusion being displaced upwardly or downwardly relative to the door frame to prevent the panel body from moving forwardly or rearwardly relative to the door frame, and a fastening protrusion coupled to the door frame to prevent the panel body from moving upwardly or downwardly relative to the door frame, the fastening protrusion being located below the fitting protrusion.

### CROSS-REFERENCE TO RELATED APPLICATION

This application claims priority to and the benefit of Korean Patent Application No. 10-2023-0021763, filed on Feb. 17, 2023, and Korean Patent Application No. 10-2023-0173655, filed on Dec. 4, 2023, the disclosures of which are incorporated herein by reference in their entireties.

### BACKGROUND

### Field

The present disclosure relates to a home appliance, and more specifically, to a home appliance equipped with a door that opens and closes an inner space thereof.

### Description of Related Art

A home appliance, such as a cooking appliance, a refrigerator, a laundry treating apparatus, etc., that has a door and accommodates an object in an inner space is widely used.

The home appliance may include a cabinet constituting an outer appearance thereof and having a receiving space defined therein for accommodating the object therein, and a door for opening and closing the receiving space. The home appliance may include two or more doors as needed.

Generally, the door of the home appliance is opaque. Therefore, when the door closes the receiving space, it is difficult to observe the object received inside the receiving space. In the home appliance equipped with such a door, the door has to be opened to observe the object contained within the receiving space.

However, in the home appliance, such as the refrigerator, an oven, and a dryer, when the door is opened, cold air or hot air inside the home appliance leaks out, which may cause unnecessary energy loss.

Further, the door of some home appliances, such as an oven, a washing machine, a dryer, etc., may include a viewing window. As the viewing window is mounted on the door, a status of the object inside the home appliance may be observed through the viewing window.

The door equipped with the viewing window may include a door frame constituting a frame of the door, a door glass mounted on the door frame, and a fixing structure for attaching the door glass to the door frame.

### SUMMARY

A purpose of the present disclosure is to provide a home appliance with an improved structure such that a door panel constituting a front outer appearance of the door may be easily and quickly installed on the door and stably coupled to the door.

Moreover, another purpose of the present disclosure is to provide a home appliance with an improved structure so that damage to the door panel may be suppressed during a door panel replacement process.

Moreover, still another purpose of the present disclosure is to provide a home appliance with an improved structure so as to prevent a structure for installing the door panel on the door from deteriorating the aesthetics of the door.

According to one aspect of the present disclosure, a door panel coupled to the door frame to define an outer appearance of the door is coupled to the door frame via a fitting protrusion. Forward and backward movement of the panel body is restricted in a state in which a position of the fitting protrusion fitted with the door frame has been changed in a vertical direction.

Moreover, according to another aspect of the present disclosure, a door panel coupled to the door frame to define an outer appearance of the door is coupled to the door frame via a fitting protrusion and a fastening protrusion. Forward and backward movement of the panel body is restricted in a state in which a position of the fitting protrusion fitted with the door frame has been changed in a vertical direction. The fastening protrusion is coupled to the door frame to restrain upward and downward movement of the panel body.

Moreover, according to still another aspect of the present disclosure, the door panel coupled to the door frame to define the outer appearance of the door is coupled to the door frame via a slidable fastening structure.

A home appliance according to one aspect of the present disclosure includes a body having an inner space defined therein; and a door configured to open and close the inner space, wherein the door includes a door frame located in front of the body, and a door panel located in front of the door frame, wherein the door panel includes a panel body being located in front of the door frame and covering the door frame, a fitting protrusion fitted with the door frame to couple the panel body to the door frame, and a fastening protrusion located under the fitting protrusion and coupled to the door frame.

In this regard, the fitting protrusion fitted with the door frame is displaced upwardly or downwardly to prevent the panel body from moving forwardly or rearwardly, wherein the fastening protrusion is coupled to the door frame to prevent the panel body from moving upwardly or downwardly.

In one embodiment of the home appliance, the door frame includes a panel support portion constituting a front surface of the door frame, and a top protrusion located in front of the panel support portion, and spaced, by a predetermined spacing, from the panel support portion in a front-rear direction.

In this regard, at least a portion of the fitting protrusion is inserted into a fastening groove defined between the panel support portion and the top protrusion.

In one embodiment of the home appliance, the fitting protrusion includes a rearwardly-extending protrusion portion protruding rearwardly from the panel body, and an upwardly-extending protrusion portion protruding upwardly from the rearwardly-extending protrusion portion.

In this regard, the upwardly-extending protrusion portion is inserted into the fastening groove.

In one embodiment of the home appliance, a top of the upwardly-extending protrusion portion protrudes upwardly beyond a top of the panel body.

In one embodiment of the home appliance, the panel body is located in front of the fitting protrusion so as to cover the fitting protrusion, wherein the top protrusion is inserted into a space surrounded with the panel body and the fitting protrusion.

In one embodiment of the home appliance, the door frame includes a panel support portion constituting a front surface of the door frame, and a fitting hole extending through the panel support portion in a front-rear direction.

In this regard, the fitting protrusion includes a protrusion body protruding rearwardly from the panel body; and a stopper portion protruding upwardly from the protrusion body.

In this regard, when the door panel moves backwards, the stopper portion passes through the panel support portion through the fitting hole, wherein when the door panel moves upwardly, at least a portion of the stopper portion is located on top of the fitting hole so as to face a rear surface of the panel support portion.

In one embodiment of the home appliance, a recess is defined in the fitting protrusion and is positioned at a connection portion between the protrusion body and the stopper portion.

In this regard, the recess is formed in a shape in which at least one of a top surface of the protrusion body or a front surface of the stopper portion is concavely rearwardly or downwardly depressed.

In one embodiment of the home appliance, the fitting protrusion has a curved portion constituting an edge connecting a rear surface and a top surface of the stopper portion to each other.

In this regard, the curved portion connects the rear surface and the top surface of the stopper portion to each other in a round shape.

In one embodiment of the home appliance, the door frame includes a panel support portion constituting a front surface of the door frame, a top protrusion located in front of the panel support portion and spaced, by a predetermined spacing, from the panel support portion in a front-rear direction, and a fitting hole located between a lower end of the panel support portion and the top protrusion and formed so as to extend through the panel support portion in the front-rear direction.

In this regard, the door panel further includes a rib protruding from the panel body and located between the panel body and the panel support portion.

In this regard, the rib is in contact with the panel support portion when the door panel is coupled to the door frame.

In this regard, the fitting protrusion includes a first fitting protrusion inserted into a fastening groove defined between the panel support portion and the top protrusion and fitted with the panel support portion; and a second fitting protrusion located between the first fitting protrusion and the fastening protrusion and fitted with the panel support portion through the fitting hole.

In one embodiment of the home appliance, the second fitting protrusion includes a pair of second fitting protrusions arranged horizontally and spaced from each other by a predetermined spacing, wherein the fitting protrusion further includes a third fitting protrusion located between the pair of second fitting protrusions and fitted with the panel support portion.

In one embodiment of the home appliance, the fitting protrusion includes a plurality of first fitting protrusions arranged horizontally and spaced from each other by a predetermined spacing, wherein a plurality of third fitting protrusions is positioned between the pair of second fitting protrusions.

In this regard, each of the third fitting protrusions is located between the first fitting protrusions adjacent to each other in a horizontal direction.

In one embodiment of the home appliance, the fitting protrusion includes a plurality of first fitting protrusions arranged horizontally and spaced from each other by a predetermined spacing.

In this regard, one of the plurality of first fitting protrusions located at a horizontal center of the door panel has a length in the horizontal direction larger than a length in the horizontal direction of each of remaining ones of the plurality of first fitting protrusions located at positions other than the horizontal center of the door panel.

In one embodiment of the home appliance, the fitting protrusion further includes a third fitting protrusion located between the first fitting protrusion and the fastening protrusion and fitted with the panel support portion.

In this regard, one of the plurality of first fitting protrusions located at the horizontal center of the door panel is located between the pair of third fitting protrusions that are horizontally spaced apart.

In one embodiment of the home appliance, the door frame includes a first fastening groove defined so as to be recessed in a front surface of the door frame rearwardly; and a fastening boss located on top of the first fastening groove.

In this regard, the fastening protrusion is inserted into the first fastening groove so as to face the fastening boss in a vertical direction, wherein the home appliance further includes a fastener passing through the fastening protrusion and the fastening boss facing each other in the vertical direction to couple the fastening protrusion and the fastening boss to each other.

In one embodiment of the home appliance, the fastening boss is located on top of the first fastening groove, wherein the door panel includes a second fastening groove defined so as to be recessed upwardly in a bottom surface of the fastening protrusion.

In this regard, the fastener includes a body passing through the fastening protrusion and the fastening boss and a head connected to the body and exposed downwardly of the fastening boss, wherein the head is accommodated in the second fastening groove.

In one embodiment of the home appliance, the door frame includes a fitting hole recessed in a front surface of the door frame in a rearward direction, wherein the fastening protrusion is fitted with the door frame through the fitting hole.

In one embodiment of the home appliance, a bottom surface of the door frame and the fastening protrusion face each other in the vertical direction, wherein the home appliance further includes a fastener passing through the fastening protrusion and the bottom surface of the door frame facing each other in the vertical direction to couple the door frame and the fastening protrusion to each other.

In one embodiment of the home appliance, the door frame includes a fastening groove defined so as to be recessed upwardly in a bottom surface of the door frame; and a fastening boss located on top of the fastening groove, wherein the fastener includes a body passing through the fastening protrusion and the fastening boss, and a head connected to the body and exposed downwardly of the fastening boss, wherein the head is accommodated in the fastening groove.

In one embodiment of the home appliance, the home appliance further comprises a cap located under the head so as to cover the head, wherein the cap is inserted into the fastening groove.

In the home appliance of the present disclosure, the outer appearance design of the door may be easily and efficiently changed, the installation of the door panel may be done easily and quickly, and the door panel may be stably coupled to the door.

In other words, according to the present disclosure, the door panel may be installed easily and quickly by pushing the door panel backwards and fitting the same with the door frame, and then pushing the door panel upwardly. Further, various types of protrusions and fasteners may be used to stably couple the door panel to the door frame in various ways.

Moreover, according to the present disclosure, the door panel may be installed by pushing the door panel backwards and fitting the same with the door frame, and then pushing the door panel upwardly. Thus, during the installation and removal process of the door panel, a force that may cause deformation or damage to the door panel or the door frame may not be applied thereto.

According to the present disclosure, damage to the door panel and the door during the door panel replacement process may be suppressed.

Moreover, according to the present disclosure, the structure for installing the door panel on the door frame is not exposed to the outside out of the door, so that the structure for installing the door panel on the door frame does not damage the aesthetics of the door, thereby improving the aesthetics of the door.

### BRIEF DESCRIPTION OF DRAWINGS

FIG. 1 is a perspective view showing a home appliance according to a first embodiment of the present disclosure.

FIG. 2 is a perspective view showing an open state of a cooking chamber of the home appliance as shown in FIG. 1.

FIG. 3 is a front perspective view showing a door according to the first embodiment of the present disclosure.

FIG. 4 is a front exploded perspective view showing a disassembled state of the door as shown in FIG. 3.

FIG. 5 is a front perspective view showing a separated door frame as shown in FIG. 4.

FIG. 6 is a rear perspective view showing a rear surface of the door panel as shown in FIG. 4.

FIG. 7 is a cross-sectional view showing a disassembled state of the door frame and the door panel as shown in FIG. 4.

FIG. 8 and FIG. 9 are cross-sectional views showing a first coupled state of the door frame and the door panel as shown in FIG. 7.

FIG. 10 and FIG. 11 are cross-sectional views showing a second coupled state of the door frame and the door panel as shown in FIG. 9.

FIG. 12 is an exploded perspective view showing a disassembled state of a door according to a second embodiment of the present disclosure.

FIG. 13 is a cross-sectional view showing a disassembled state of a door frame and a door panel as shown in FIG. 12.

FIG. 14 and FIG. 15 are cross-sectional views showing a first coupled state of the door frame and the door panel as shown in FIG. 13.

FIG. 16 and FIG. 17 are cross-sectional views showing a second coupled state of the door frame and the door panel as shown in FIG. 15.

FIG. 18 is an exploded perspective view showing a disassembled state of a door according to a third embodiment of the present disclosure.

FIG. 19 is a perspective view showing a separated door panel as shown in FIG. 18.

FIG. 20 is a cross-sectional view showing a disassembled state of a door frame and a door panel as shown in FIG. 18.

FIG. 21 and FIG. 22 are cross-sectional views showing a first coupled state of the door frame and the door panel as shown in FIG. 20.

FIG. 23 and FIG. 24 are cross-sectional views showing a second coupled state of the door frame and the door panel as shown in FIG. 22.

FIG. 25 is a front perspective view showing a door according to a fourth embodiment of the present disclosure.

FIG. 26 is a front exploded perspective view showing a disassembled state of the door as shown in FIG. 25.

FIG. 27 is a front perspective view showing a separated door frame as shown in FIG. 25.

FIG. 28 is a rear perspective view showing a rear surface of a door panel as shown in FIG. 25.

FIG. 29 is a cross-sectional view showing a coupled state of the door frame and the door panel as shown in FIG. 25.

FIG. 30 is an enlarged view showing a top coupled state of the door frame and the door panel as shown in FIG. 29.

FIG. 31 is an enlarged view showing a bottom coupled state of the door frame and the door panel as shown in FIG. 29.

FIG. 32 is a front perspective view showing a door according to a fifth embodiment of the present disclosure.

FIG. 33 is a cross-sectional view showing a first coupled state of a door frame and a door panel as shown in FIG. 32.

FIG. 34 is a cross-sectional view showing a second coupled state of the door frame and the door panel as shown in FIG. 33.

FIG. 35 is a front perspective view showing a door according to a sixth embodiment of the present disclosure.

FIG. 36 is a cross-sectional view showing a first coupled state of a door frame and a door panel as shown in FIG. 35.

FIG. 37 is a cross-sectional view showing a second coupled state of the door frame and the door panel as shown in FIG. 36.

FIG. 38 to FIG. 40 are cross-sectional views showing a coupling process of the door frame and the door panel to each other.

### DETAILED DESCRIPTIONS

The above-mentioned purposes, features, and advantages will be described in detail later with reference to the attached drawings, so that those skilled in the art in the technical field to which the present disclosure belongs may easily implement the technical ideas of the present disclosure. In describing the present disclosure, when it is determined that a detailed description of the publicly known technology related to the present disclosure may unnecessarily obscure the gist of the present disclosure, the detailed description will be omitted. Hereinafter, exemplary embodiments according to the present disclosure will be described in detail with reference to the attached drawings. In the drawings, identical reference numerals are used to indicate identical or similar components.

Although first, second, and the like are used to describe various components, these components are not limited by such terms. Such terms are only used to distinguish one component from another component, and unless specifically stated to the contrary, a first component may also be a second component.

The present disclosure may not be limited to embodiments disclosed below, and various changes may be made and the present disclosure may be implemented in various different forms. The present embodiment is provided solely to ensure that the disclosure of the present disclosure is complete and to fully inform those skilled in the art of the scope of the invention. Therefore, it should be understood that the present disclosure is not limited to the embodiments disclosed below, but includes all changes, equivalents, or substitutes included in the technical idea and the scope of the present disclosure, as well as substitution of components of one embodiment with components of another embodiment and addition of components.

The attached drawings are only for easy understanding of the embodiments disclosed herein, and the technical ideas disclosed herein are not limited by the attached drawings. Further, it should be understood that the present disclosure includes all modifications, equivalents, or substitutions that fall within the technical concept and scope of the present disclosure. In drawings, components may be expressed exaggeratedly large or small in size or thickness for convenience of understanding or the like, but the scope of protection of the present disclosure should not be interpreted as limited by the same.

The terms used herein are merely used to describe specific implementations or embodiments, and are not intended to limit the present disclosure. Further, singular expressions include plural expressions, unless the context clearly dictates otherwise. Herein, terms such as “include”, “composed of”, and the like are intended to indicate the existence of features, numbers, steps, operations, components, parts, or combinations thereof described herein. In other words, it should be understood that terms such as “include”, “composed of”, and the like as used herein do not exclude in advance the presence or addition of one or more other features, numbers, steps, operations, components, parts, or combinations thereof.

Terms including ordinal numbers, such as first, second, and the like, may be used to describe various components, but the components are not limited by the terms. The above terms are used only for the purpose of distinguishing one component from another.

When a first component is described as being “connected” or “coupled” to a second component, it should be understood that the components may be directly connected or coupled to each other, but a third component may also be interposed between the components. On the other hand, when it is described that the first component is “directly connected” or “directly coupled” to the second component, it should be understood that there are no other components interposed therebetween.

When a first component is described to be “on top of” or “under” a second component, it is understood that the first component may be located in contact with a top surface or a bottom surface of the second component, as well as a third component may be interposed therebetween.

Unless otherwise defined, all terms used herein, including technical or scientific terms, have the same meaning as commonly understood by a person of ordinary skill in the technical field to which the present disclosure pertains. Terms defined in commonly used dictionaries should be interpreted as having a meaning consistent with the meaning in the context of the related technology, and unless explicitly defined in the present application, should not be interpreted in an ideal or excessively formal sense.

When a home appliance is located on the floor, a side on which a door is installed, relative to a center of the home appliance is defined as a front side. Therefore, a direction of opening the door and entering the home appliance becomes a rearward direction. For convenience, a direction between the front side and a rear side may be referred to as a first direction. Then, the front side may be referred to as one side in the first direction, and the rear side may be referred to as the other side in the first direction.

Additionally, the direction of gravity may be defined as a downward direction, and a direction opposite to the direction of gravity may be defined as an upward direction.

In addition, a horizontal direction orthogonal to the front and rear direction of the home appliance, that is, a width direction of the home appliance when viewing the home appliance in front of the door thereof, may be referred to as a left and right direction. For convenience, the left and right direction may be referred to as a second direction. Then, a right side may be referred to as one side in the second direction, and a left side may be referred to as the other side in the second direction.

In addition, a width direction of the home appliance may be referred to as a horizontal direction. Then, a right side may be referred to as one side in the horizontal direction, and a left side may be referred to as the other side in the horizontal direction.

In addition, the vertical direction described on top of may be referred to as a third direction. Then, an upper side may be referred to as one side in the third direction, and a bottom may be referred to as the other side in the third direction.

Additionally, the vertical direction described on top of may be referred to as a height direction. Then, the front and rear direction and the left and right direction, that is, the first direction and the second direction may be referred to as a transverse direction.

Throughout the present document, “A and/or B” means A, B, or A and B, unless otherwise specified, and “C to D” means equal to or greater than C and equal to or smaller than D unless otherwise specified.

### Overall Structure of Home Appliance

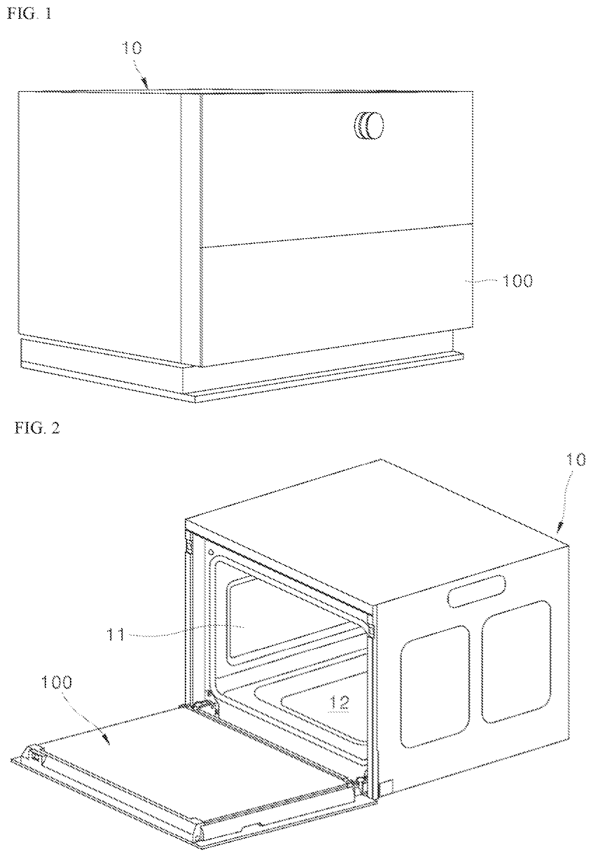

FIG. 1 is a perspective view showing a home appliance according to an embodiment of the present disclosure, and FIG. 2 is a perspective view showing an open state of a cooking chamber of the home appliance as shown in FIG. 1.

Referring to FIGS. 1 and 2, a body 10 defines an outer appearance of the home appliance according to an embodiment of the present disclosure. The body 10 may be provided in a shape including a substantially hexahedral shape. This body 10 may be made of a material having a certain strength in order to protect a number of components installed in an inner space thereof.

The body 10 may include a cavity 11. The cavity 11 may define a framework of the body 10.

A receiving space 12 may be formed inside the cavity 11. The receiving space 12 may be in a form of a hexahedron with an open front surface. When the home appliance is embodied as a cooking device, the home appliance may cook food by heating the receiving space 12.

In front of the body 10, a door 100 that selectively opens and closes the receiving space 12 may be constructed to be pivotable. The door 100 may open and close the receiving space 12 using a pull-down manner in which an upper end thereof pivots upwardly and downwardly around a lower end thereof.

In one example, the door 100 may be formed in an overall hexahedral shape with a predetermined thickness. Moreover, the door 100 may include a viewing window. The viewing window may be made of a transparent material, such as glass or transparent plastic.

Depending on a type of the home appliance on which the viewing window is installed, the viewing window may need to be formed to withstand high temperature and pressure, and the viewing window may need functions such as waterproofing and heat dissipation.

### First Embodiment of Door

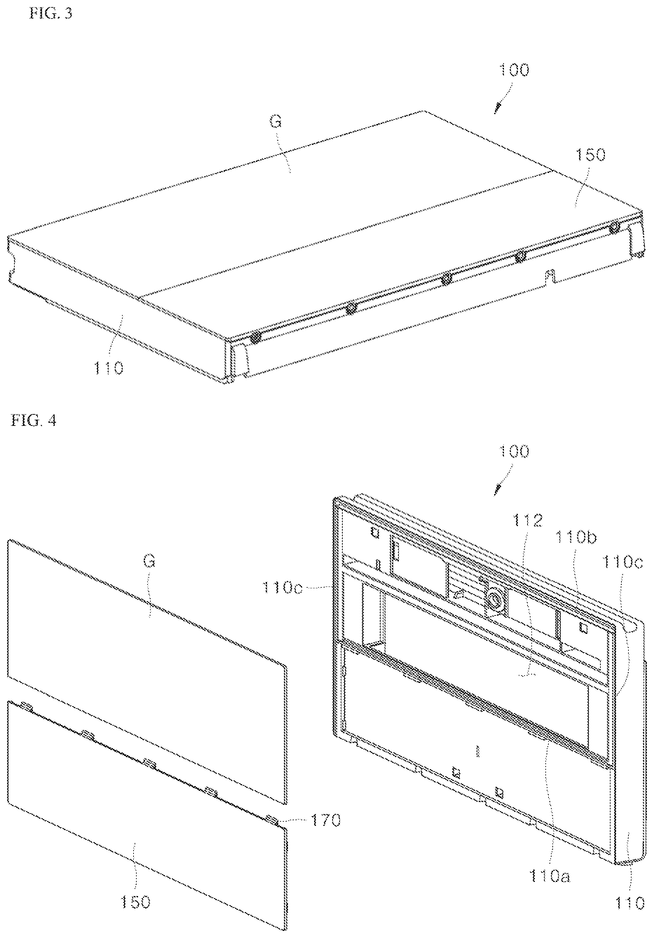

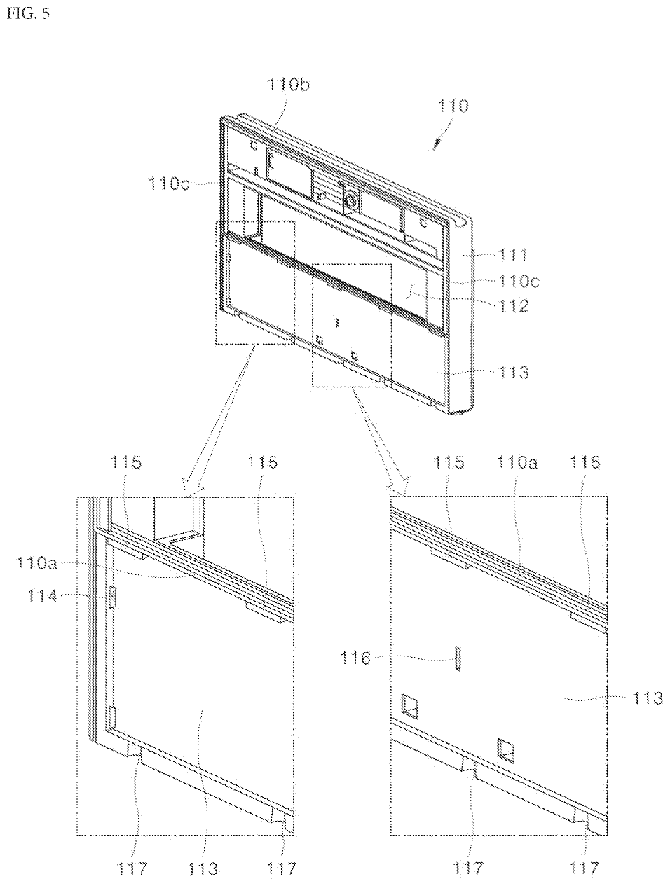

FIG. 3 is a perspective view showing a door according to a first embodiment of the present disclosure, and FIG. 4 is a front exploded perspective view showing a disassembled state of the door as shown in FIG. 3.

Referring to FIGS. 2 to 4, a door 100 may include a door frame 110.

The door frame 110 defines a framework of the door 100 and may constitute a top outer appearance, a bottom outer appearance, and a side outer appearance of the door 100. In one example, the door frame 110 may be formed in an approximately hexahedral shape.

A hinge may be installed at a bottom of the door frame 110 to couple the door frame 110 to the body 100 so as to be pivotable. The hinge may be installed at a bottom of the door frame 110, but may be installed at opposing sides of the door frame 110.

The door 100 may further include a door glass G. The door glass G may be located in front of the door frame 110. The door glass G may be coupled to the door frame 110 while being located in front of the door frame 110 and may constitute a front outer appearance of the door 100.

The door frame 110 may include a through-opening 112. The through-opening 112 may be formed to extend through the door frame 110 in a front-rear direction. The door glass G may cover the through-opening 112 while being located in front thereof and may be coupled to the door frame 110. In this way, a state inside the receiving space 12 may be checked by a user in front of the door 100 through the door glass G provided on the door 100.

Moreover, the door 100 may further include a door panel 150. Like the door glass G, the door panel 150 may be located in front of the door frame 110 and may be coupled to the door frame 110 while being located in front of the door frame 110 and may constitute the front outer appearance of the door 100.

In one example, the door glass G and the door panel 150 may be arranged in a vertical direction. In this embodiment, the door panel 150 is illustrated as being located under the door glass G. The door panel 150 arranged in this way together with the door glass G may constitute the front outer appearance of the door 100.

The door panel 150 may be detachably coupled to the door frame 110. Details regarding a coupling structure between the door panel 150 and the door frame 110 will be described later.

In addition, the door 100 may further include a rear panel. The rear panel may be coupled to a rear side of the door frame 110 to constitute a rear portion of the door 100.

In the door 100, a space surrounded by the door frame 110 and the rear panel may be defined. In this inner space, at least a portion of the hinge may be accommodated, and a damper, etc. to reduce a rotational speed of the door 100 may be accommodated.

### Structure of Door Frame

FIG. 5 is a front perspective view showing the separated door frame as shown in FIG. 4.

Referring to FIG. 4 and FIG. 5, the door frame 110 may include a frame body 111. The frame body 111 may constitute the framework of the door frame 110.

In one example, the frame body 111 may be formed in a substantially flat hexahedral shape. In this frame body 111, the through-opening 112 may be formed to extend through in the forward and backward directions. For example, the frame body 111 may be formed in a rectangular ring shape.

The door frame 110 may further include a panel support portion 113. The panel support portion 113 may constitute a front portion of the door frame 110. In one example, the panel support portion 113 may constitute a lower half of the front portion of the door frame 110. This panel support portion 113 may be located at a front side of the frame body 111 and may be located under the through-opening 112.

The panel support portion 113 may be located at a rear of the door panel 150. This panel support portion 113 may support the door panel 150 while being at the rear of the door panel 150. In one example, the panel support portion 113 may be formed in a rectangular plate shape.

The door frame 110 may include a first fitting hole 114 and a second fitting hole 116. Each of the first fitting hole 114 and the second fitting hole 116 may be formed to extend through the panel support portion 113 in the forward and backward directions.

The first fitting hole 114 may be constructed so that a second fitting protrusion 180 which will be described later may be inserted therein. The second fitting hole 116 may be constructed so that a third fitting protrusion 185, which will be described later may be inserted therein.

In this embodiment, the first fitting hole 114 is located at each of opposing ends of the panel support portion 113, and the second fitting hole 116 is located approximately in a center of the panel support portion 113. Moreover, in this embodiment, a plurality of first fitting holes 114 are arranged in a vertical direction at each end of the panel support portion 113.

Moreover, the door frame 110 may further include a door glass mount. The door glass mount may be located along a vertical outer edge of the panel support portion 113.

In this embodiment, it is illustrated that the door glass mount includes a plurality of edge protrusions. Each edge protrusion may be formed to protrude from a vertical edge of the door frame 110 in a frontward direction.

In one example, the door glass mount may include a lower edge protrusion 110a, an upper edge protrusion 110b, and a pair of side edge protrusions 110c. The lower edge protrusion 110a and the upper edge protrusion 110b may be arranged to be spaced apart from each other in a vertical direction while the through-opening 112 is located therebetween.

The pair of side edge protrusions 110c may be arranged to be spaced apart from each other in a horizontal direction while the through-opening 112 is located therebetween. Each side edge protrusion 110c may extend in the vertical direction and connect the lower edge protrusion 110a and the upper edge protrusion 110b to each other.

The upper edge protrusion 110b may be formed to protrude from an upper edge of the door frame 110 in the frontward direction. The pair of side edge protrusions 110c may be formed to respectively protrude from opposing side edges of the door frame 110 in the frontward direction.

The lower edge protrusion 110a may be located between the through-opening 112 and the panel support portion 113 and may be formed to protrude from a lower edge of the panel support portion 113 in the frontward direction Accordingly, a step may be formed between the door glass mount 110a and the panel support portion 113.

The door glass G may be located in an inner area inwardly of the door glass mount, that is, an area surrounded with the lower edge protrusion 110a, the upper edge protrusion 110b, and the pair of side edge protrusions 110c. This door glass G may be installed into the door frame 110 so as to be fitted into the door glass mount in the inner area inwardly of the door glass mount.

In one example, a bottom of the door glass G may be supported on a top of the door panel 150. In another example, the lower end of the door glass G may be supported on a rearwardly-extending protrusion portion 172 of a first fitting protrusion 170 which will be described later. In still another example, the bottom of the door glass G may be supported on the lower edge protrusion 110a.

Moreover, the door frame 110 may further include a top protrusion 115. The top protrusion 115 may be located on a protrusion formed on an upper edge of the panel support portion 113, that is, the lower edge protrusion 110a. This top protrusion 115 may protrude downwardly from the lower edge protrusion 110a.

The top protrusion 115 formed to protrude in this way may be located in front of the panel support portion 113. This top protrusion 115 may be spaced apart from the panel support portion 113 by a predetermined distance in the front-rear direction. In one example, a spacing between the top protrusion 115 and the panel support portion 113 may be set to correspond to a front-rear thickness of an upwardly-extending protrusion portion 171 which will be described later.

Accordingly, a fitting groove may be formed between the panel support surface 113 and the upper protrusion 115. The fitting groove is formed in the shape of a groove open downward, and the upper protrusion 171 is fitted into the fitting groove.

In one example, the door frame 110 may include a plurality of top protrusions 115. For example, the plurality of top protrusions 115 may be located on the door frame 110 and arranged horizontally and spaced from each other by at a predetermined spacing.

In addition, the door frame 110 may further include a first fastening groove 117. The first fastening groove 117 may be located in a bottom of the door frame 110. The first fastening groove 117 may be constructed so that a fastening protrusion 190 which will be described later may be inserted therein.

The first fastening groove 117 may be formed in a depressed shape in a bottom of a front portion of the door frame 110. For example, the first fastening groove 117 may be concavely recessed rearwardly and may be formed to be concavely recessed upwardly in the bottom of the door frame 110. The first fastening groove 117 may be formed so as to be open downwardly and in a frontward direction.

### Structure of Door Panel

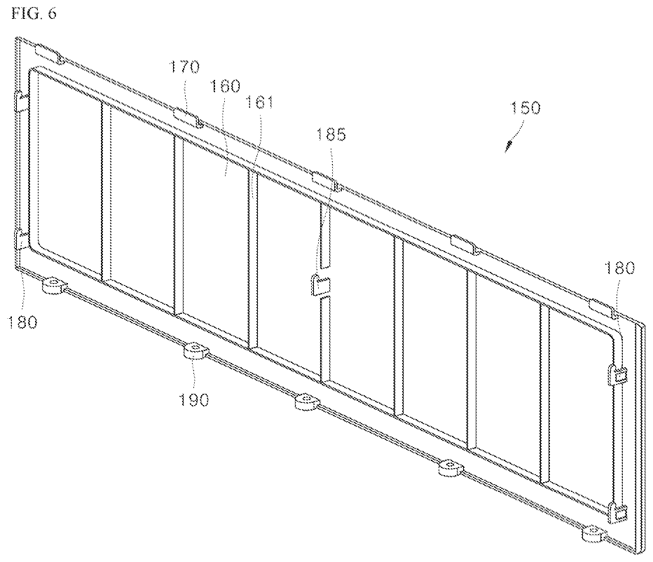

FIG. 6 is a rear perspective view showing a rear surface of the door panel as shown in FIG. 4.

Referring to FIGS. 4 to 6, the door panel 150 may include a panel body 160. The panel body 160 may constitute a framework and an outer appearance of the door panel 150. The panel body 160 may be coupled to the door frame 110 while being located in front of the door frame 110, and may be coupled to the panel support portion 113 while being located in front of the panel support portion 113.

The panel body 160 is provided to cover the door frame 110 while being located in front thereof. More specifically, the panel body 160 is provided to cover the panel support portion 113 while being located in front thereof. This panel body 160 may be formed in a shape corresponding to a shape of the panel support portion 113. In one example, the panel body 160 may be formed in a rectangular plate shape.

The panel body 160 may be formed to have various materials, colors, and designs. The door panel 150 having the panel body 160 may be constructed to be easily attached and detached to and from the front surface of the door frame 110. In other words, the door panel 150 may be easily replaced from the door 100, and thus, a material, a color, and a design of the front surface of the door 100 may be changed simply and efficiently.

To this end, the door panel 150 may include a fastening structure to removably couple the door panel 150 and the door frame 110 to each other. In one example, this fastening structure may include the first fitting protrusion 170.

The first fitting protrusion 170 may be located at a top of the door panel 150. The first fitting protrusion 170 may include the upwardly-extending protrusion portion 171 formed at the top of the door panel 150. The upwardly-extending protrusion portion 171 may be formed to protrude upwardly from the top of the door panel 150.

The upwardly-extending protrusion portion 171 may be located at a position closer to a rear surface of the panel body 160 rather than to a front surface thereof. This upwardly-extending protrusion portion 171 may be formed to protrude rearwardly from the top of the panel body 160 in a stepped shape.

In one example, the upwardly-extending protrusion portion 171 may protrude upwardly and may be located at a position closer to a rear surface of the panel body 160 rather than to a front surface thereof. This upwardly-extending protrusion portion 171 and the panel body 160 may be connected to each other via the rearwardly-extending protrusion portion 172.

For example, the rearwardly-extending protrusion portion 172 may be formed to protrude rearwardly from the panel body 160. The upwardly-extending protrusion portion 171 may be formed to protrude upwardly from the rear end of the rearwardly-extending protrusion portion 172.

In this embodiment, it is illustrated that the rearwardly-extending protrusion portion 172 connects the upper end of the panel body 160 and the lower end of the upwardly-extending protrusion portion 171 to each other. The rearwardly-extending protrusion portion 172 and the upwardly-extending protrusion portion 171 may be connected to each other in a “L” shape and may be located at the top of the panel body 160.

The upwardly-extending protrusion portion 171 may be coupled to the top protrusion 115. This upwardly-extending protrusion portion 171 may be inserted between the top protrusion 115 and the panel support portion 113 and may be coupled to the top protrusion 115.

In one example, the door panel 150 may include a plurality of first fitting protrusions 170. For example, the plurality of first fitting protrusions 170 may be arranged in a horizontal direction and may be spaced from each other by at a predetermined spacing and may be located on the door panel 150. In this regard, the plurality of first fitting protrusions 170 may be arranged so as to be spaced from each other by a spacing corresponding to a spacing between adjacent ones of the plurality of top protrusions 115.

Moreover, the fastening structure for detachably coupling the door panel 150 and the door frame 110 to each other may further include the second fitting protrusion 180 on the door panel 150.

The second fitting protrusion 180 may be located adjacent to a side of the door panel 150. The second fitting protrusion 180 may include a protrusion body 181 formed on the rear surface of the door panel 150. The protrusion body 181 may be formed to protrude rearwardly from the panel body 160.

The second fitting protrusion 180 may further include a stopper portion 183. The stopper portion 183 may be formed to protrude upwardly or downwardly from a rear end of the protrusion body 181. In this embodiment, the stopper portion 183 is illustrated as protruding upwardly from the protrusion body 181.

The second fitting protrusion 180 including the protrusion body 181 and the stopper portion 183 may protrude rearwardly from the panel body 160 and may extend in an approximately “L” shape. The second fitting protrusion 180 may be fitted with the door frame 110 through the first fitting hole 114 defined in the door frame 110.

In the door panel 150, a plurality of second fitting protrusions 180 may be formed. In this embodiment, it is illustrated that the second fitting protrusions 180 are located at each of opposing ends in a horizontal direction of the panel body 160, and are arranged vertically.

Moreover, the fastening structure for removably coupling the door panel 150 and the door frame 110 to each other may further include a third fitting protrusion 185 on the door panel 150.

In this embodiment, it is illustrated that the second fitting protrusions 180 are located at each of opposing ends of the door panel 150, and the third fitting protrusion 185 is located approximately at a center in the horizontal direction of the door panel 150. Like the second fitting protrusion 180, the third fitting protrusion 185 may be formed in a shape that protrudes rearwardly from the panel body 160, and may be formed in a shape similar to the second fitting protrusion 180. The third fitting protrusion 185 may be fitted with the door frame 110 through the second fitting hole 116 defined in the door frame 110.

According to this embodiment, the second fitting protrusion 180 may be located at each of four corners of the door panel 150, and the third fitting protrusion 185 may be located approximately at the center in the horizontal direction of the door panel 150. That is, the third fitting protrusion 185 may be located between a pair of second fitting protrusions 180 spaced apart from each other in the horizontal direction, and at the same time, may be located between a pair of second fitting protrusions 180 spaced apart from each other in the vertical direction.

The second fitting protrusion 180 and the third fitting protrusion 185 may be fitted with the door frame 110 through the first fitting hole 114 and the second fitting hole 116, respectively. Accordingly, the door panel 150 may be coupled to the door frame 110.

In this regard, the door panel 150 may be coupled to the door frame 110 at multiple points. That is, at the four corners and a central point of the door panel 150, the door panel 150 may be coupled to the door frame 110 so that the door panel 150 may be stably coupled to the door frame 110.

Moreover, the fastening structure for removably coupling the door panel 150 and the door frame 110 to each other may further include a fastening protrusion 190 on the door panel 150.

The fastening protrusion 190 may be located at the bottom of the door panel 150. A fastening hole may be formed to extend through the fastening protrusion 190 in the vertical direction.

In one example, the door panel 150 may further include a rib 161. The rib 161 may be formed to protrude rearwardly from the rear surface of the panel body 160. In this embodiment, the ribs 161 are illustrated as being formed in a stripe shape and on the rear surface of the panel body 160. The rib 161 provided in this way may increase strength of the door panel 150 and may prevent the door panel 150 from being bent.

Moreover, the rib 161 may be located between the rear surface of the panel body 160 and the panel support portion 113 of the door frame 110. In one example, an anteroposterior length of the rib 161 may be set to a length corresponding to an anteroposterior spacing between the panel body 160 and the panel support portion 113.

When the door panel 150 is coupled to the door frame 110, the rib 161 is in contact with the panel support portion 113 to maintain the spacing between the panel body 160 and the panel support portion 113.

Moreover, the rib 161 may support the door frame 150 so as to prevent the door panel 150 from being deformed in a depressed manner when the door panel 150 is pressed against the door frame 110 in order to couple the door panel 150 to the door frame 110. In particular, when the door panel 150 and the door frame 110 are assembled with each other in a lying state, the rib 161 may stably support the door panel 150 to prevent the door panel 150 from being deformed in a depressed manner when the door panel 150 is pressed against the door frame 110.

### Coupling Structure Between Door Frame and Door Panel

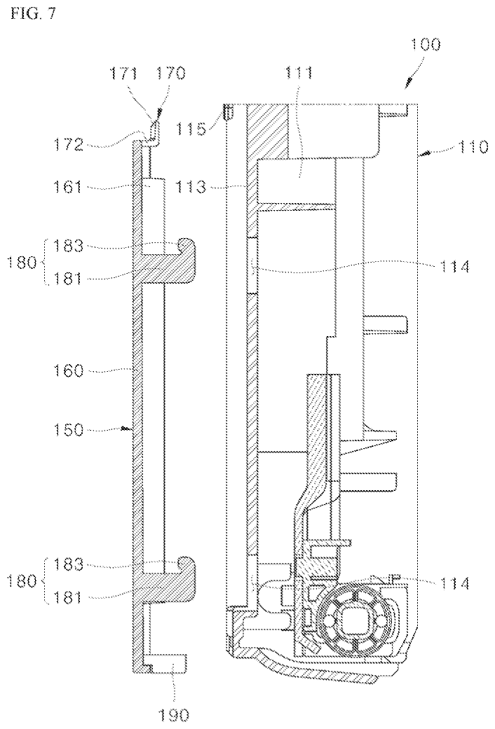

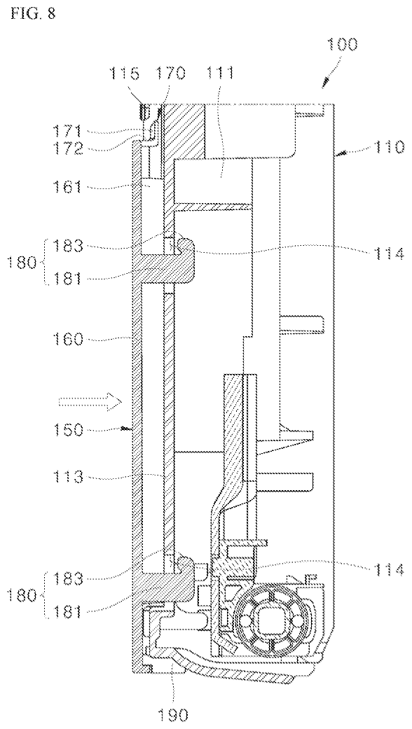

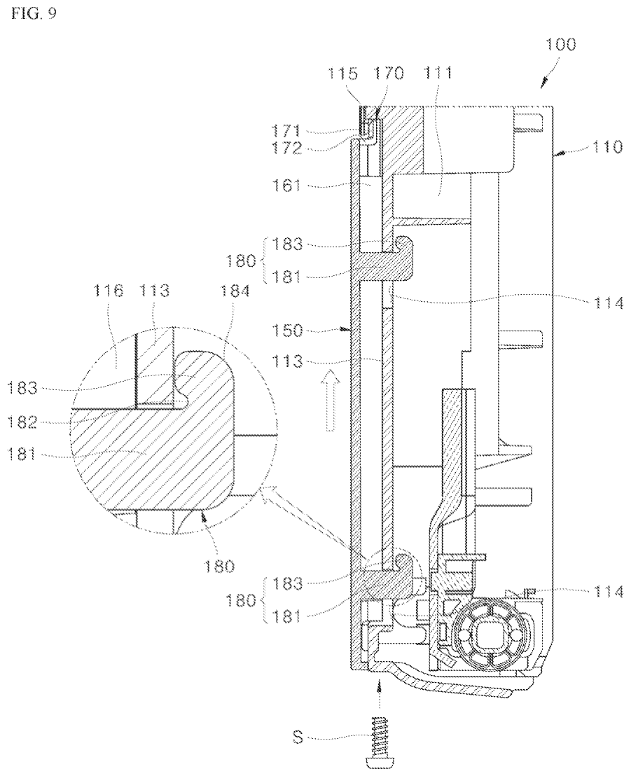

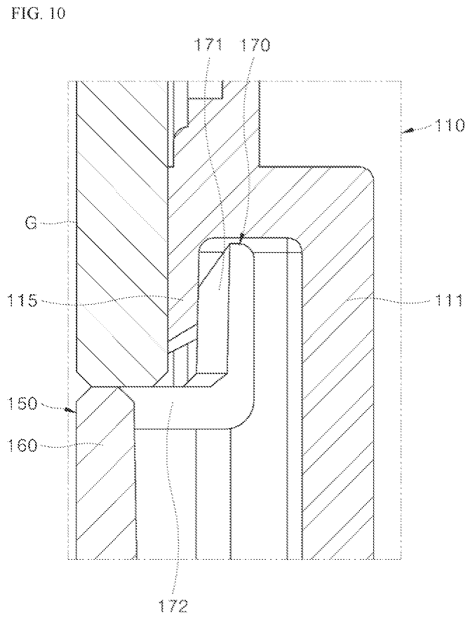

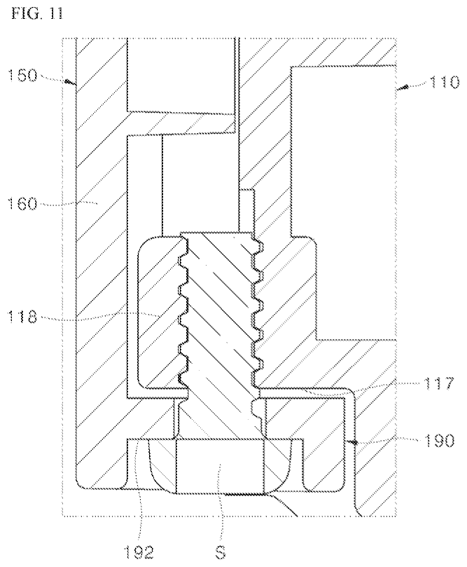

FIG. 7 is a cross-sectional view showing a disassembled state of the door frame and the door panel as shown in FIG. 4, and FIG. 8 and FIG. 9 are cross-sectional views showing a first coupled state of the door frame and the door panel as shown in FIG. 7. FIG. 10 and FIG. 11 are cross-sectional views showing a second coupled state of the door frame and the door panel as shown in FIG. 9.

Referring to FIGS. 5 to 8, the coupling between the door frame 110 and the door panel 150 may be achieved via coupling between the first fitting protrusion 170, the second fitting protrusion 180, the third fitting protrusion 185, and the fastening protrusion 190 of the door panel 150 and the door frame 110.

In a state in which the door panel 150 is separated from the door frame 110, the door panel 150 from a position in front of the door frame 110 may be displaced toward and coupled to the door frame 110. In this process, the second fitting protrusion 180 may pass through the panel support portion 113 in the front-rear direction through the first fitting hole 114, and the third fitting protrusion 185 may pass through the panel support portion 113 in the front-rear direction through the second fitting hole 116.

At this time, the panel body 160 may be located in front of the panel support portion 113. While the rib 161 is in contact with the panel support portion 113, the door panel 150 may be seated on a front surface of the panel support portion 113. Further, the rear end of the protrusion body 181 and the stopper portion 183 may protrude rearwardly beyond the rear surface of the panel support portion 113, and the rear end of the third fitting protrusion 185 may protrude rearwardly beyond the rear surface of the panel support portion 113.

In a state in which the door panel 150 has been first coupled to the door frame 110, the door panel 150 is pushed upwardly as shown in FIG. 9, such that the first fitting protrusion 170, the second fitting protrusion 180, and the third fitting protrusion 185 may be fitted into and coupled to the door frame 110.

When the door panel 150 is pushed upwardly while the door panel 150 has been first coupled to the door frame 110, the stopper portion 183 of the second fitting protrusion 180 moves upwardly relative to the first fitting hole 114, such that the stopper portion 183 may face the rear surface of the panel support portion 113 in the front-rear direction.

As a result, the panel support portion 113 may be inserted between the panel body 160 and the stopper portion 183, more specifically, between the rib 161 and the stopper portion 183. Accordingly, the fitting coupling between the door frame 110 and the protrusion body 181 may be achieved. In addition, the fitting coupling as shown above between the door frame 110 and the third fitting protrusion 185 may be achieved.

The second fitting protrusion 180 may have a recess 182 defined therein. The recess 182 may be defined at a connection portion between the protrusion body 181 and the stopper portion 183. In one example, the recess 182 may be formed in a shape in which a front surface of the stopper portion 183 facing the rear surface of the panel body 160 is concavely recessed rearwardly.

In another example, the recess 182 may be formed in a shape in which a top surface of the protrusion body 181 is concavely recessed downwardly. In still another example, the recess 182 may be formed in a shape in which a front surface of the stopper portion 183 is concavely recessed rearwardly and, at time same time, the top surface of the protrusion body 181 is concavely recessed downwardly.

In this embodiment, the stopper portion 183 is connected to the protrusion body 181 at a right angle relative to the protrusion body 181, and the stopper portion 183 may constitute a vertical wall extending parallel to the protrusion body 181. The panel support portion 113 may be inserted between the stopper portion 183 and the rib 161.

When the door panel 150 is formed, there may be cases where the second fitting protrusion 180 is formed such that an angle defined between the stopper portion 183 and the protrusion body 181 is slightly larger or smaller than a right angle. In consideration of this possibility, in this embodiment, the recess 182 is formed in the second fitting protrusion 180.

The recess 182 defined in the second fitting protrusion 180 may allow an amount by which the stopper portion 183 is bent around the connection portion between the protrusion body 181 and the stopper portion 183 to be increased. That is, an elastic bent deformation amount of the stopper portion 183 may be increased due to the recess 182 defined in the second fitting protrusion 180.

Accordingly, interference may occur between the panel support portion 113 and a portion of the protrusion body 181 when the second fitting protrusion 180 passes through the first fitting hole 114. However, even in this case, due to the recess 182, the stopper portion 183 is elastically bent, such that the second fitting protrusion 180 may easily pass through the first fitting hole 114.

Moreover, when the panel support portion 113 is inserted between the stopper portion 183 and the rib 161, a gap between the stopper portion 183 and the rib 161 may be smaller than the thickness of the panel support portion 113. However, even in this case, the stopper portion 183 is bent elastically, such that the panel support portion 113 may be inserted between the stopper portion 183 and the rib 161.

In addition, the stopper portion 183 may have a curved portion 184. The curved portion 184 may be located along an edge connecting the rear surface and the top surface of the stopper portion 183 to each other, and an adjacent area to the edge. This curved portion 184 may constitute a curved surface connecting the rear surface and the top surface of the stopper portion 183 to each other in a rounded manner.

The curved portion 184 formed in this way may allow the stopper portion 183 to smoothly pass through the first fitting hole 114 when the second fitting protrusion 180 passes through the panel support portion 113 through the first fitting hole 114.

The features such as the recess 182 and the curved portion 184 as described on top thereof may be applied only to the second fitting protrusion 180 and/or may also be equally applied to the third fitting protrusion 185. In this embodiment, it is illustrated that the features such as the recess 182 and the curved portion 184 are applied to the third fitting protrusion 185 as well as the second fitting protrusion 180.

Via the coupling of the second fitting protrusion 180 and the third fitting protrusion 185 to the door frame 110 as described above, an anteroposterior position of the door panel 150 with respect to the door frame 110 may be restrained.

Moreover, the coupling of the second fitting protrusion 180 and the third fitting protrusion 185 to the door frame 110 may be achieved in a press-fitting manner. In this case, a vertical directional movement of the door panel 150 relative to the door frame 110 may be restrained.

In addition, the first fitting protrusion 170 and the top protrusion 115 may be coupled to each other at the top of the door panel 150. As shown in FIG. 9 and FIG. 10, when the door panel 150 is pushed upwardly while the door panel 150 has been first coupled to the door frame 110, the upwardly-extending protrusion portion 171 of the first fitting protrusion 170 may be positioned so as to face the rear surface of the top protrusion 115 in the anteroposterior direction.

As a result, the upwardly-extending protrusion portion 171 may be inserted into the fitting groove formed between the panel support portion 113 and the top protrusion 115, and thus the fitting coupling between the door frame 110 and the upwardly-extending protrusion portion 171 may be achieved. Due to the fitting coupling between the door frame 110 and the upwardly-extending protrusion portion 171 as described above, the upper end of the door panel 150 may be detachably coupled to the door frame 110.

In addition, at the bottom of the door panel 150, coupling between the fastening protrusion 190 and the first fastening groove 117 may be achieved. As shown in FIG. 9 and FIG. 11, when the door panel 150 is pushed upwardly while the door panel 150 has been first coupled to the door frame 110, the fastening protrusion 190 may be inserted into the first fastening groove 117.

According to this embodiment, the first fastening groove 117 may be formed in an upwardly recessed manner from a bottom, that is, may be open downwardly, and further, may be open in the frontward direction.

The fastening protrusion 190 positioned under the first fastening groove 117 may move upwardly along the door panel 150 when the door panel 150 is pushed upwardly and then may be inserted into the first fastening groove 117. In this regard, a portion of the first fastening groove 117 that is open in the frontward direction may provide a passage necessary for upward movement of a connection portion between the fastening protrusion 190 and the panel body 160.

That is, in this embodiment, the first fastening groove 117 may be formed so as to be open toward a position in front of the door frame 110, that is, in the frontward direction. Thus, the portion of the first fastening groove 117 formed in the door frame 110 is open in the frontward direction, such that the fastening protrusion 190 and the first fastening groove 117 may be engaged with each other via the upward movement of the door panel 150.

In other words, the coupling between the fastening protrusion 190 and the first fastening groove 117 in this embodiment may be achieved via the upward movement of the door panel 150. For the coupling between the fastening protrusion 190 and the first fastening groove 117, the door panel 150 does not need to pivot forwardly or rearwardly around the top of the door panel 150.

As described above, the fastening protrusion 190 may be inserted into the first fastening groove 117 and may be coupled to the bottom of the door frame 110. In this regard, the fastening protrusion 190 may be in contact with a top surface of the first fastening groove 117.

In addition, the door frame 110 may have a fastening boss 118. The fastening boss 118 may be located on top of the first fastening groove 117. This fastening boss 118 may have a fastening hole defined therein so as to extend through the boss 118 in the vertical direction.

When the fastening protrusion 190 is inserted into the first fastening groove 117, the fastening hole formed in the fastening protrusion 190 and the fastening hole formed in the fastening boss 118 may communicate with each other in the vertical direction. The fastening protrusion 190 and the door frame 110 may be fastened to each other via a fastener S such as a screw.

The fastener S may extend through the fastening protrusion 190, the first fastening groove 117, and the fastening boss 118 and may fasten the fastening protrusion 190 and the door frame 110 to each other. A portion of the fastener S protruding out of the fastening protrusion 190 may be received in a second fastening groove 192 of the fastening protrusion 190.

In one example, the fastener S may be embodied as a screw including a body and a head. The body of the screw may pass through the first fastening groove 117 and the fastening boss 118. The head may be a portion connected to the body and protruding downwardly beyond the fastening boss 118.

As described above, the door panel 150 may be removably coupled to the door frame 110 using the first fitting protrusion 170, the second fitting protrusion 180, the third fitting protrusion 185, and the fastening protrusion 190. This door panel 150 may be first coupled to the door frame 110 using the first fitting protrusion 170, the second fitting protrusion 180, and the third fitting protrusion 185. Then, the door panel 150 may be firmly fixed to the door frame 110 by fastening the fastening protrusion 190 to the door frame 110 using the fastener S.

That is, in this embodiment, the door panel 150 may be easily and quickly coupled to the door frame 110 by an operator pushing the door panel 150 backwards and fitting the door panel 150 into the door frame 110 and then pushing the door panel 150 upwardly. The door panel 150 may be stably coupled to the door frame 110 in various ways using various types of protrusions and fasteners.

Moreover, the door panel 150 may be stably fitted with the door frame 110 by fitting the door panel into the door frame 110 in the front and rear direction and then simply moving the door panel upwardly without having to pivot the door panel in the front and rear direction. As a result, the door panel 150 may be installed efficiently even in a narrow space where it is difficult to pivot the door panel 150 forwards and backwards.

Moreover, the door panel 150 may be installed simply on the door frame 110 by simply fastening the fastener S to the door frame in a state in which the door panel 150 has been easily and efficiently first fitted into the door frame 110. The door panel 150 may be easily removed from the door frame 110 by simply unscrewing the fastener S that has screw-coupled the door panel 150 and the door frame 110 to each other.

In the home appliance of this embodiment equipped with the door 100 as described above, the outer appearance design of the door 100 may be changed simply and efficiently.

### Second Embodiment of Door

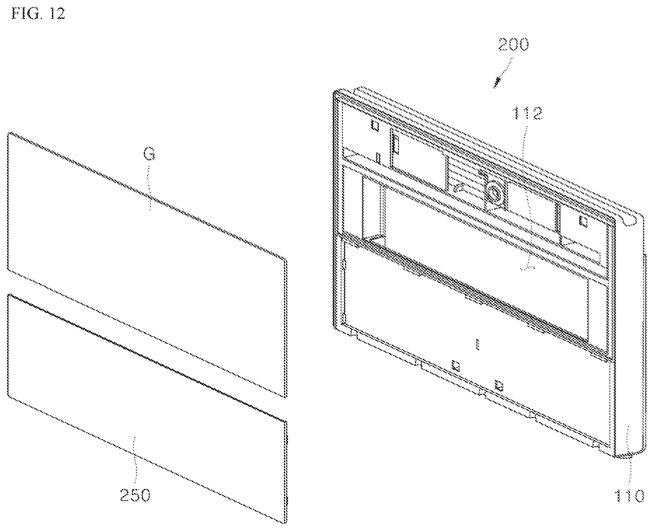

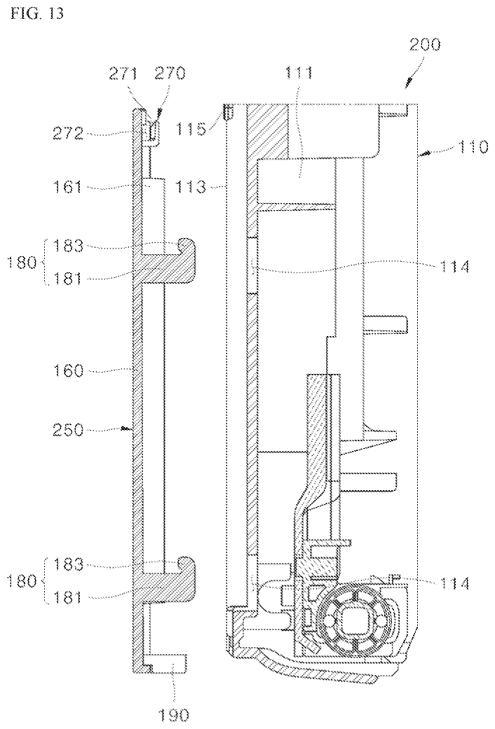

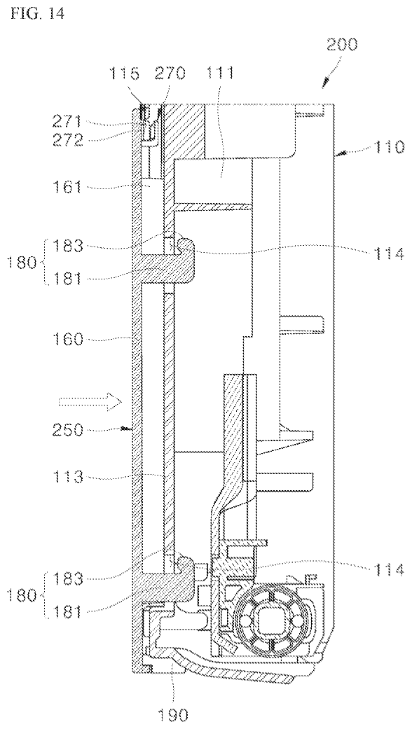

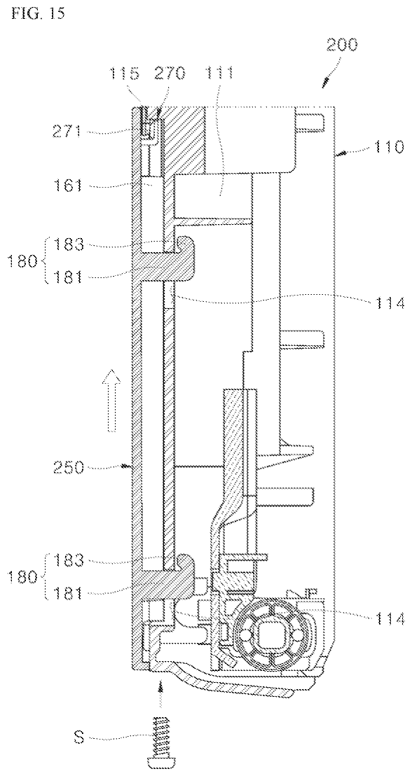

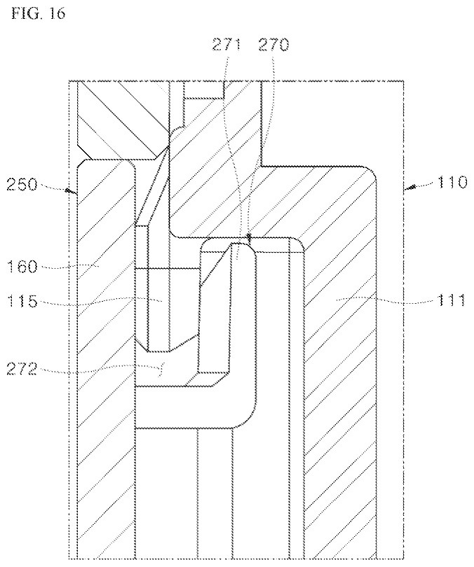

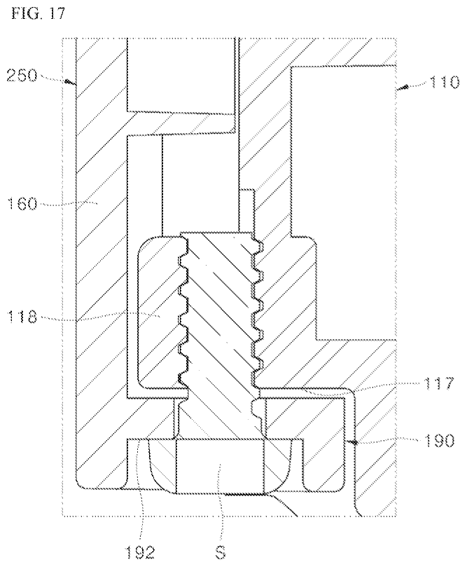

FIG. 12 is an exploded perspective view showing a disassembled state of the door according to the second embodiment of the present disclosure, and FIG. 13 is a cross-sectional view showing a disassembled state of the door frame and the door panel as shown in FIG. 12. Moreover, FIG. 14 and FIG. 15 are cross-sectional views showing a first coupled state of the door frame and the door panel as shown in FIG. 13. FIG. 16 and FIG. 17 are cross-sectional views showing a second coupled state of the door frame and the door panel as shown in FIG. 15.

Referring to FIGS. 12 to 14, a main difference between the door illustrated in the preceding embodiment and a door 200 according to the second embodiment of the present disclosure relates to a first fitting protrusion 270 of a door panel 250.

According to this embodiment, the first fitting protrusion 270 is located on the rear surface of the panel body 160 and does not protrude upwardly beyond the panel body 160. The first fitting protrusion 270 may include a L-shape portion 271 protruding rearwardly and then upwardly while being located in rear of the panel body 160.

A first fastening groove 272 may be defined by the first fitting protrusion 270. The first fastening groove 272 may be defined as a space surrounded with the L-shaped portion 271 formed as described on top of and the panel body 160.

As shown in FIGS. 15 to 17, when the door panel 250 is pushed upwardly while the door panel 250 has been first coupled to the door frame 110, the top protrusion 115 may be inserted into the first fastening groove 272 such that the door panel 250 may be coupled to the top protrusion 115 in a fitting manner.

In this regard, the door panel 250 may cover the top protrusion 115 while being located in front of the top protrusion 115 and may be coupled to the top protrusion 115. That is, in this embodiment, when the door panel 250 is coupled to the door frame 110, the door panel 250 may cover the top protrusion 115 while being located in front of the top protrusion 115 to prevent the top protrusion 115 from being exposed to an outside out of the door 200.

The door panel 250 of this embodiment configured in this way may prevent a structure for installing the door panel 110 to the door 200, such as the top protrusion 115, from being exposed to the outside out of the door, thereby improving aesthetics of the door 200.

### Third Embodiment of Door

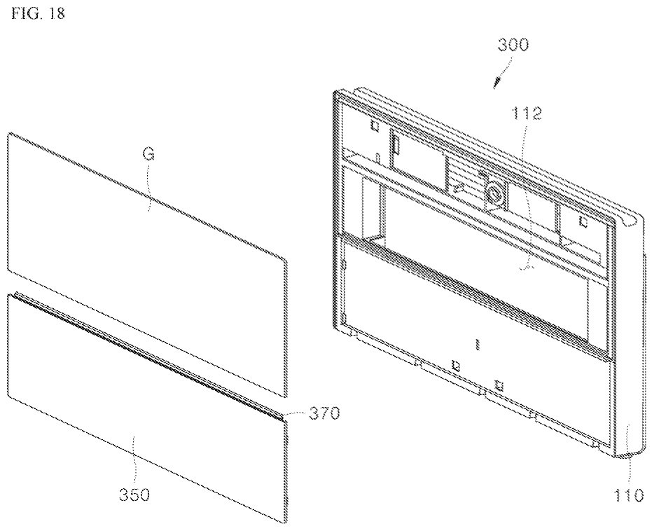

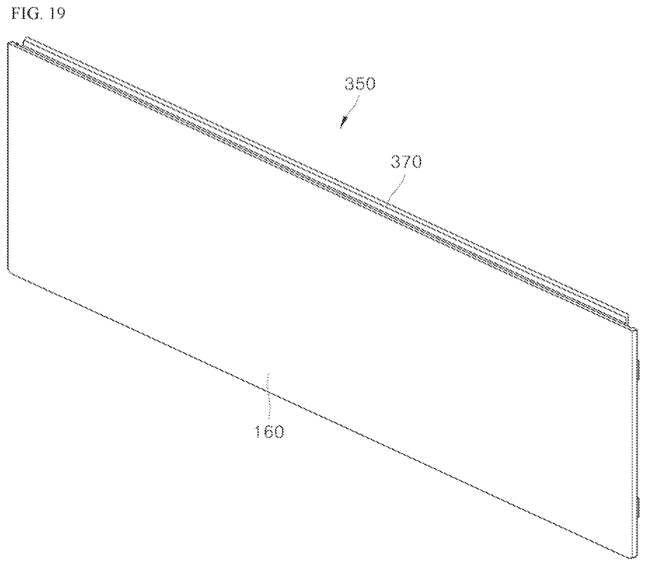

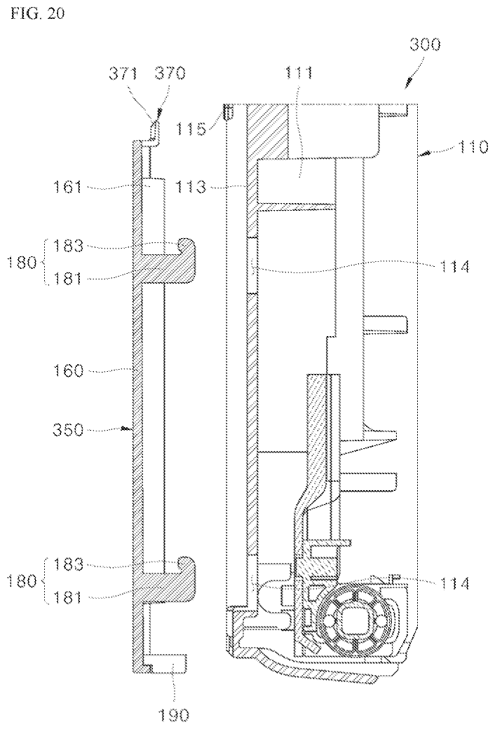

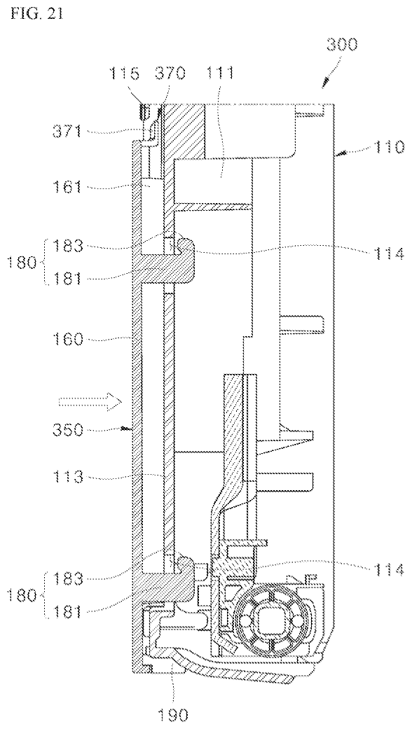

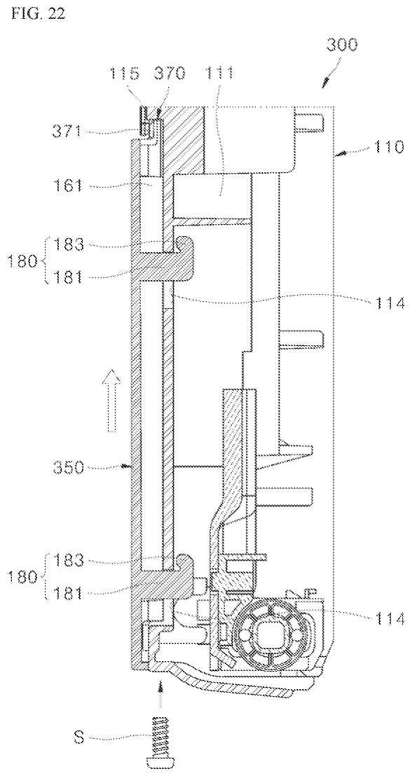

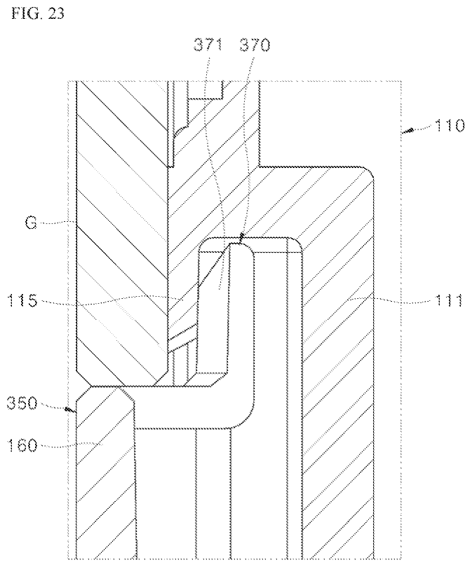

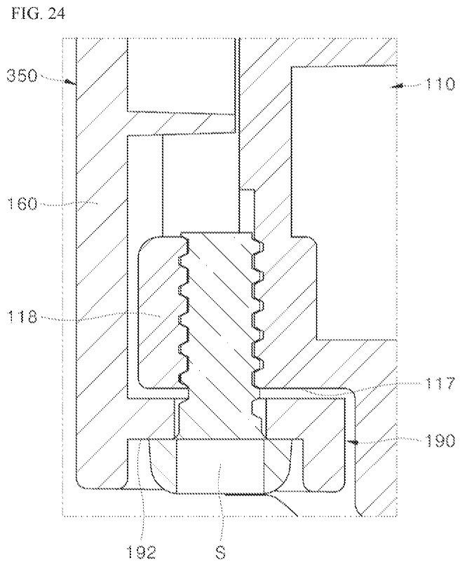

FIG. 18 is an exploded perspective view showing a disassembled state of the door according to the third embodiment of the present disclosure. FIG. 19 is a perspective view showing the separated door panel as shown in FIG. 18. and FIG. 20 is a cross-sectional view showing a disassembled state of the door frame and the door panel as shown in FIG. 18. Moreover, FIG. 21 and FIG. 22 are cross-sectional views showing a first coupled state of the door frame and the door panel as shown in FIG. 20. FIG. 23 and FIG. 24 are cross-sectional views of a second coupled state of the door frame and the door panel as shown in FIG. 22.

Referring to FIGS. 18 to 24, a main difference between the door illustrated in the preceding embodiments and a door 300 according to the third embodiment of the present disclosure relates to a first fitting protrusion 370 of a door panel 350.

Like the first fitting protrusion 170 (see FIG. 6) as illustrated in the first embodiment of the present disclosure, the first fitting protrusion 370 of this embodiment may include a L-shaped portion 371 protruding upwardly beyond the top of the panel body 160.

The L-shaped portion 371 of this embodiment is different from the first upwardly-extending protrusion portion 171 (see FIG. 7) illustrated in the first embodiment of the present disclosure in that the L-shaped portion 371 of this embodiment has a single continuous structure.

That is, in the first embodiment of the present disclosure, the upwardly-extending protrusion portion 171 is connected to the rearwardly-extending protrusion portion 172 to constitute the first fitting protrusion 170. However, the L-shaped portion 371 of this embodiment has a single continuous structure.

The L-shaped portion 371 provided in this way may contribute to allowing the top of the door panel 350 to be more stably supported on the door frame 110 and to allowing the door panel 350 to be stably coupled to the door frame 110.

### Fourth Embodiment of Door

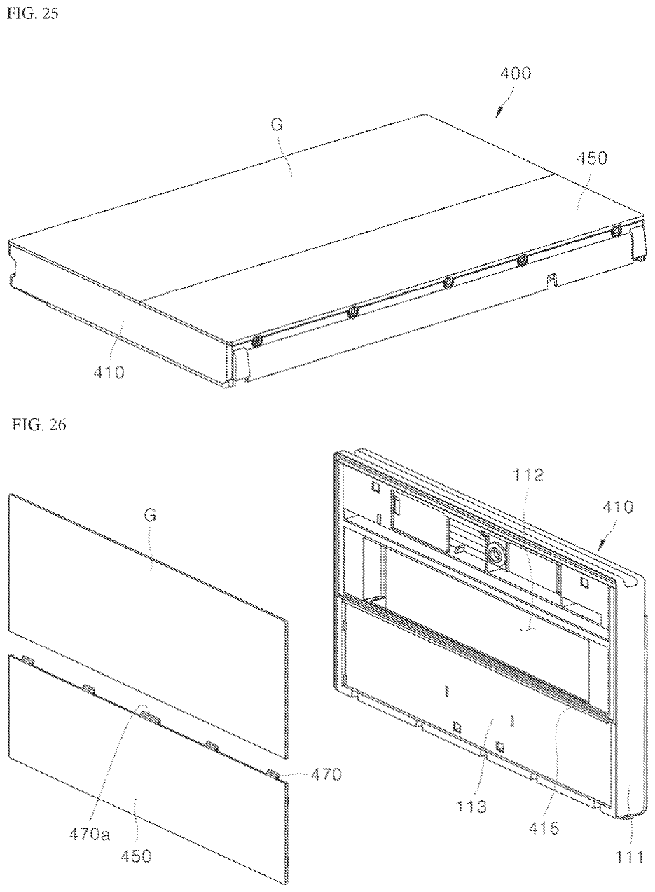

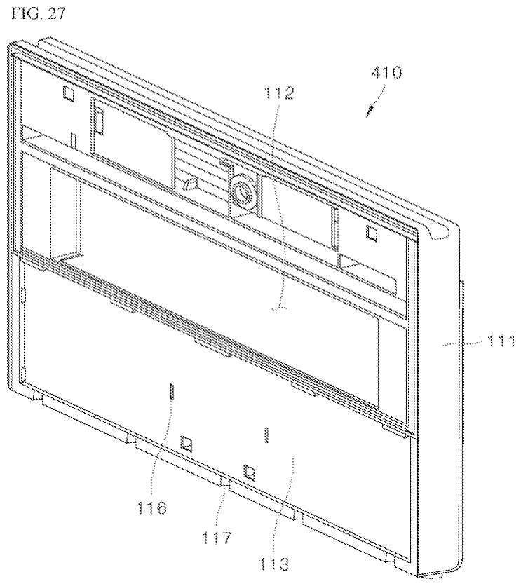

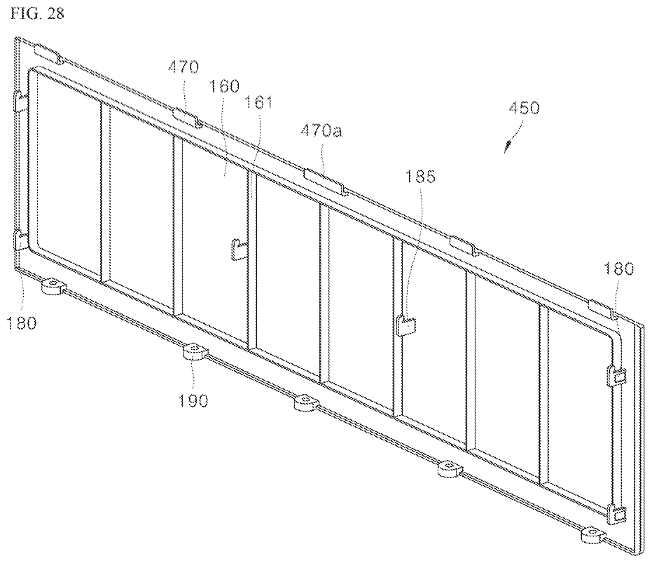

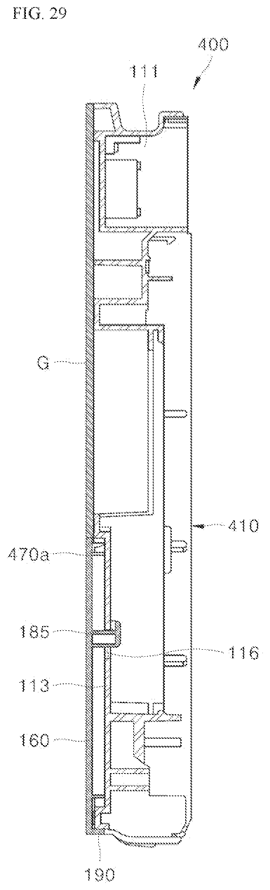

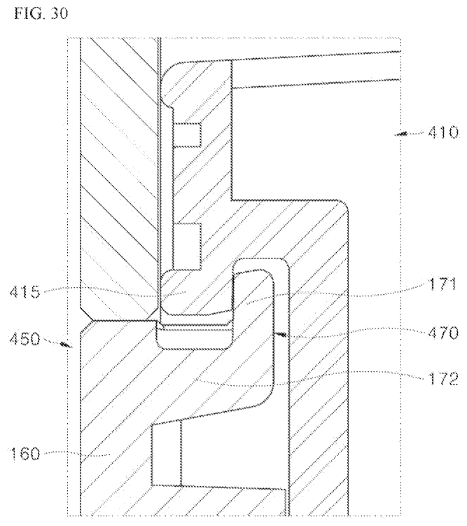

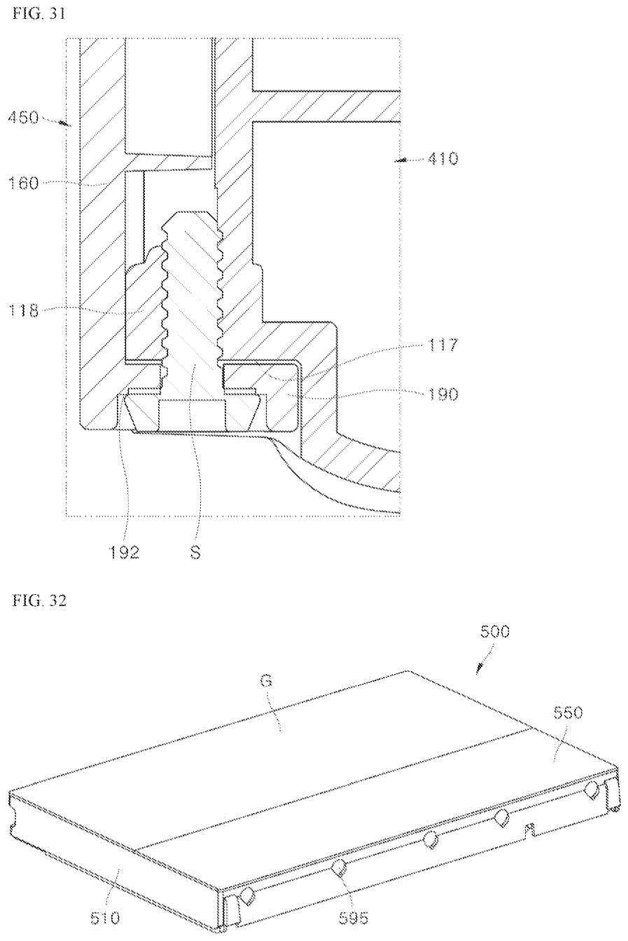

FIG. 25 is a front perspective view showing the door according to the fourth embodiment of the present disclosure. FIG. 26 is a front exploded perspective view showing a disassembled state of the door as shown in FIG. 25. FIG. 27 is a front perspective view showing a separated door frame as shown in FIG. 25. Moreover, FIG. 28 is a rear perspective view showing a rear surface of the door panel as shown in FIG. 25. FIG. 29 is a cross-sectional view showing a coupled state of the door frame and the door panel as shown in FIG. 25. Moreover, FIG. 30 is an enlarged view showing a top coupled state of the door frame and the door panel as shown in FIG. 29. FIG. 31 is an enlarged view showing a bottom coupled state of the door frame and the door panel as shown in FIG. 29.

Referring to FIGS. 25 to 31, a main difference between the door illustrated in the above-described embodiments and a door 400 according to the fourth embodiment of the present disclosure relates to a top protrusion 415 of a door frame 410, and first fitting protrusions 470 and 470a and a third fitting protrusion 185 of a door panel 450.

A difference between the top protrusion 415 of this embodiment and the first upwardly-extending protrusion portion 115 (see FIG. 5) illustrated in the first embodiment of the present disclosure is that the top protrusion 415 of this embodiment has a single continuous structure.

The top protrusion 415 of the present embodiment provided in this way may more stably support the first fitting protrusions 470 and 470a inserted between the panel support portion 113 and the top protrusion 415, such that the top of the door panel 450 may be more stably supported on the door panel 410 and the door panel 450 may be stably coupled to the door frame 410.

Moreover, the first fitting protrusions 470 and 470a of this embodiment may be located at the top of the door panel 450, like the first fitting protrusion 170 (see FIG. 6) illustrated in the first embodiment of the present disclosure. Moreover, at the top of the door panel 450, a plurality of first fitting protrusions 470 and 470a may be arranged so as to be spaced from each other by at a predetermined spacing along the horizontal direction.

In this embodiment, the first fitting protrusion 470a (hereinafter referred to as “central protrusion”) located at a horizontal center of the door panel 450 among the plurality of first fitting protrusions 470 and 470a may have a length in the horizontal direction larger than that of the first fitting protrusion 470 located at a position other than the horizontal center of the door panel 450 among the plurality of first fitting protrusions 470 and 470a.

As the central protrusion 470a which has the horizontal length larger than that of the first fitting protrusion 470 is located at the horizontal center of the door panel 450, a center of the top of the door panel 450 may be supported more stably on the door frame 410.

According to this embodiment, each of the horizontally opposing ends of the door panel 450 may be coupled to the door frame 410 via the first fitting protrusion 470, and further, via the plurality of second fitting protrusions 180 arranged in the vertical direction. That is, each of the horizontally opposing ends of the door panel 450 may be coupled to the door frame 410 via the fitting protrusions at three or more points and the fastening protrusion 190 and thus be firmly supported on the door frame 410.

The horizontal center of the door panel 450 may be coupled to the door frame 410 only via the central protrusion 470a. That is, the horizontal center of the door panel 450 may be coupled to the door frame 410 at only one point, except for a coupling point corresponding to the fastening protrusion 190.

Therefore, the horizontal center of the door panel 450 may be likely to be less firmly supported on the door frame 410 than each of the horizontally opposing ends of the door panel 450 may be.

With considering this situation, in this embodiment, the central protrusion 470a having the larger horizontal length than that of the first fitting protrusion 470 is located at the horizontal center of the door panel 450. The central protrusion 470a having this feature may contribute to allowing the center of the top of the door panel 450 to be more stably supported on the door frame 410.

In addition, the door frame 410 of this embodiment may include a plurality of third fitting protrusions 185. In one example, the plurality of third fitting protrusions 185 may be arranged horizontally and spaced from each other by a predetermined spacing.

Each of the third fitting protrusions 185 may be located between the first fitting protrusion 470 and 470a and the fastening protrusion 190 in the vertical direction. In the horizontal direction, each of the third fitting protrusions 185 may be located between the first fitting protrusions 470 and 470a adjacent to each other. For example, in a specific area of the door frame 410, the first fitting protrusions 470 and 470a and the third fitting protrusions 185 may be arranged alternately with each other along the horizontal direction.

In one example, a pair of third fitting protrusions 185 may be located under the central protrusion 470a, and may be arranged so as to be spaced from each other by a predetermined spacing horizontally while the central protrusion 470a is located therebetween.

The plurality of third fitting protrusion 185 arranged as above may allow the central area of the door panel 450 to be coupled to the door panel 450 at multiple points, so that the central area of the door panel 450 may be supported more stably on the door frame 410.

Moreover, the plurality of third fitting protrusions 185 as described on top of may be arranged so as to be spaced from each other by a predetermined spacing horizontally while the central protrusion 470a is located therebetween. Each of the plurality of third fitting protrusions 185 may be coupled to the door frame 410 at a point between a point where the central protrusion 470a and the door frame 410 are coupled to each other and a point where the second fitting protrusion 180 and the door frame 410 are coupled to each other.

That is, the third fitting protrusions 185 may be respectively located at a point between the horizontal center of the door panel 450 and each of the horizontally opposing ends of the door panel 450 where the coupling between the door panel 450 and the door frame 410 is stable, and a point between each of the first fitting protrusions 470 and 470a and the fastening protrusion 190, and may be coupled to the door frame 410.

The third fitting protrusions 185 coupled to the door frame 410 in this way may contribute to allowing an entire area of the door panel 450 including a central area in the vertical direction of the door panel 450 to be more stably supported on the door frame 410. support.

### Fifth and Sixth Embodiments of Door

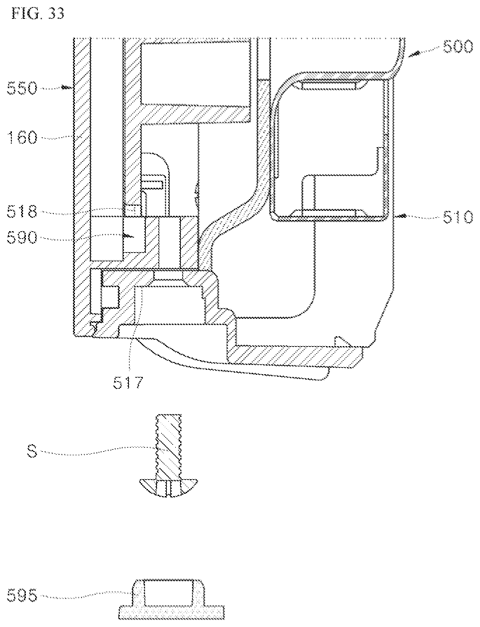

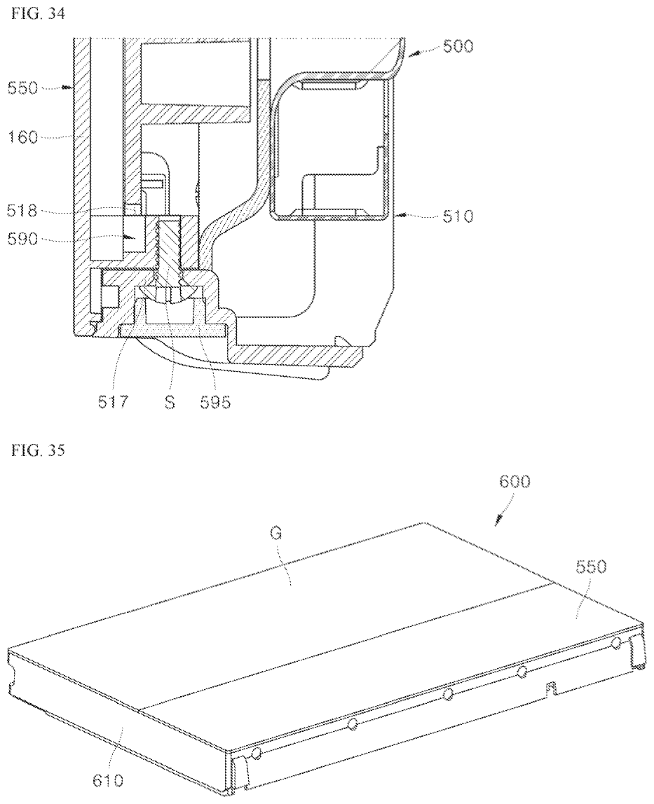

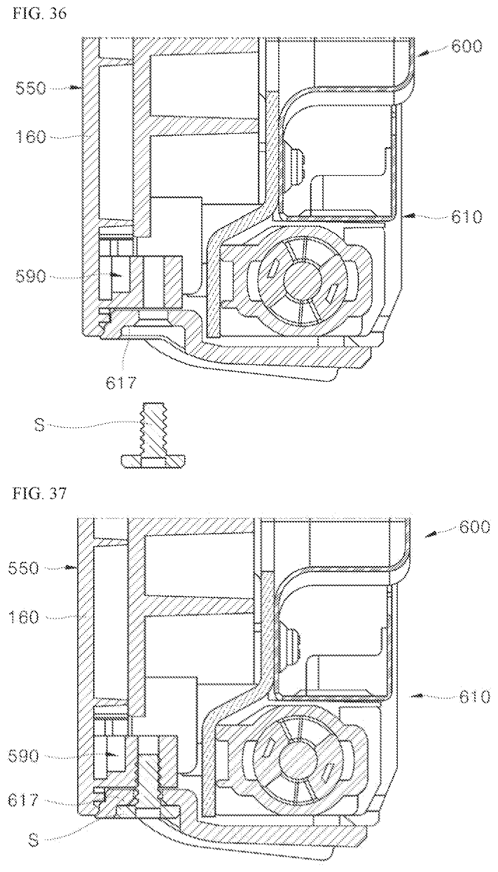

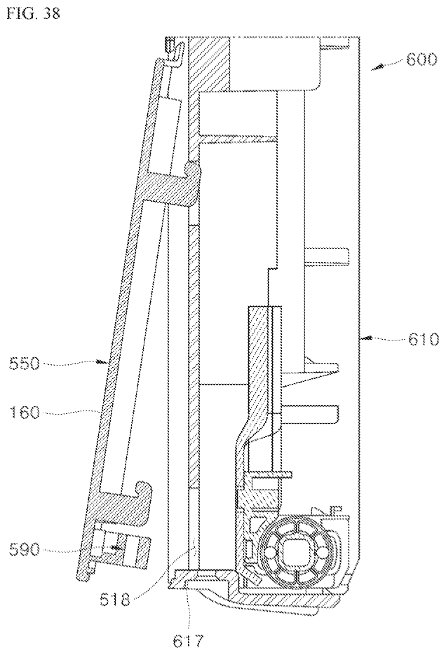

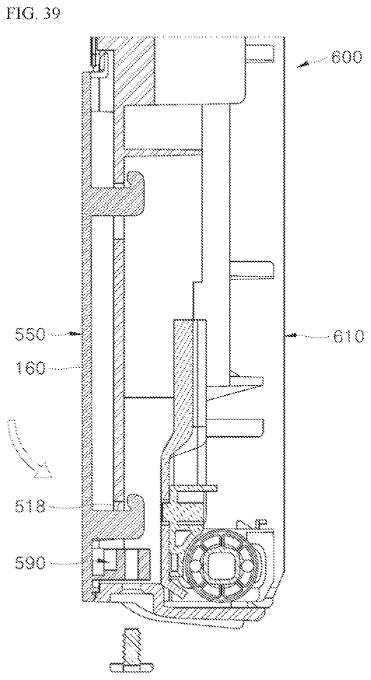

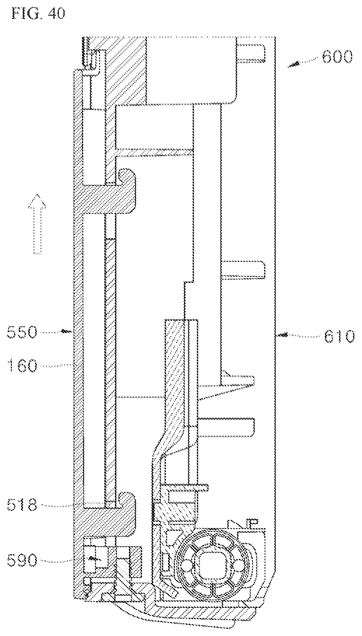

FIG. 32 is a front perspective view showing a door according to a fifth embodiment of the present disclosure. FIG. 33 is a cross-sectional view showing a first coupled state of a door frame and a door panel as shown in FIG. 32. FIG. 34 is a cross-sectional view showing a second coupled state of the door frame and the door panel as shown in FIG. 33. FIG. 35 is a front perspective view showing a door according to a sixth embodiment of the present disclosure. FIG. 36 is a cross-sectional view showing a first coupled state of a door frame and a door panel as shown in FIG. 35. FIG. 37 is a cross-sectional view showing a second coupled state of the door frame and the door panel as shown in FIG. 36. FIG. 38 to FIG. 40 are cross-sectional views showing a coupling process of the door frame and the door panel to each other.

Referring to FIG. 32 and FIG. 33, a door panel 550 according to the fifth embodiment of the present disclosure may include a fastening protrusion 590.

Moreover, the door panel 550 of this embodiment may further include the first fitting protrusion, the second fitting protrusion, and the third fitting protrusion illustrated in the above-described embodiment. In this regard, the door panel 550 may include any one of the various types of first fitting protrusions illustrated in the above-described embodiments.

According to this embodiment, the fastening protrusion 590 may protrude rearwardly from the panel body 160, and may be located at a position slightly spaced upwardly from the bottom of the panel body 160. This fastening protrusion 590 may be located on top of a first fastening groove 517.

In other words, the fastening protrusion 590 may be located on top of the first fastening groove 517 and may face the first fastening groove 517 in the vertical direction when the door panel 550 has been first coupled to the door frame 510.

In a corresponding manner thereto, a third fitting hole 518 may be defined in the door frame 510. The third fitting hole 518 may be formed to extend through the panel support portion 113 in the front-rear direction. The third fitting hole 518 may be constructed so that the fastening protrusion 590 may be inserted therein. The number of the third fitting holes 518 may correspond to the number of the fastening protrusions 590. The third fitting holes 518 may be arranged so as to be spaced from each other by a spacing corresponding to a spacing between the fastening protrusions 590.

Each of the third fitting holes 518 may be located adjacent to a bottom of the panel support portion 113. In this embodiment, the third fitting hole 518 is illustrated as being located above the first fastening groove 517.

Each fastening protrusion 590 may be fitted with the door frame 510 through the third fitting hole 518 and may be located so as to face the first fastening groove 517 in the vertical direction and in the door frame 510.

While, as described above, the fastening protrusion 590 and the first fastening groove 517 face each other in the vertical direction, the fastening protrusion 590 and the door frame 110 may be fastened to each other via a fastener S.

In this regard, a portion (for example, a head of a screw) of the fastener S exposed to an outside out of the fastening protrusion 590 may be accommodated in the first fastening groove 517.

In addition, the door 500 of this embodiment may further include a cap 595. The cap 595 may be inserted into the first fastening groove 517 through an open bottom of the first fastening groove 517, as shown in FIG. 34. The cap 595 inserted into the first fastening groove 517 may cover the head of the fastener S while being located thereunder and may be inserted into the first fastening groove 517.

The cap 595 may be provided as a finishing material that covers an area in which the fastening protrusion 590 and the door frame 110 are coupled to each other. Due to the cap 595, the aesthetics of the door 500 may be more effectively improved.

In another example, as shown in FIGS. 35 to 37, a first fastening groove 617 provided at the bottom of the door frame 610 may be provided in a depressed form having a relatively shallow depth compared to a depth of the fastening groove 517 illustrated in the fifth embodiment of the present disclosure. In this case, a door 600 may be free of a cap.

Referring to FIG. 38, the door panel 550 may be installed on the door frame 510 in a following manner.

In a state where the door panel 550 is separated from the door frame 510, the door panel 550 may be coupled to the door frame 510 while being in front of the door frame 510.

For the coupling between the door frame 510 and the door panel 550, coupling between the first fitting protrusion and the top protrusion 115 (see FIG. 10) may first be achieved. In this regard, the first fitting protrusion may be selected as one of the first fitting protrusions as illustrated in the first to third embodiments of the present disclosure.

The coupling between the first fitting protrusion and the top protrusion 115 may be achieved by moving the first fitting protrusion in an inclined manner toward the top protrusion 115 so as to be fitted with the top protrusion 115. The first fitting protrusion fitted with the top protrusion 115 in the inclined manner may pivot backwards around a top thereof fitted with the top protrusion 115 such that the first fitting protrusion is inserted between the panel support portion 113 and the top protrusion 115. Accordingly, a fitting coupling between the door frame 510 and the first fitting protrusion may be achieved.

In a state where the door frame 510 and the first fitting protrusion have been fitted with each other as described above, the door panel 550 may pivot rearwardly around the first fitting protrusion, such that the second fitting protrusion 180 and the third fitting protrusion 185 are inserted into the first fitting hole 114 (see FIG. 5) and the second fitting hole 116 (see FIG. 5), respectively. Thus, the couplings between the second fitting protrusion 180 and the third fitting protrusion 185 and the door frame 510 may be achieved together.

At the same time, at the bottom of the door panel 550, coupling between the fastening protrusion 590 and the first fastening groove 117 may be made. The coupling between the fastening protrusion 590 and the first fastening groove 117 may be achieved using the fastener S.

Although the embodiments of the present disclosure have been described in more detail with reference to the accompanying drawings, the present disclosure is not necessarily limited to these embodiments, and may be modified in a various manner within the scope of the technical spirit of the present disclosure. Accordingly, the embodiments as disclosed in the present disclosure are intended to describe rather than limit the technical idea of the present disclosure, and the scope of the technical idea of the present disclosure is not limited by these embodiments. Therefore, it should be understood that the embodiments described on top of are not restrictive but illustrative in all respects. In addition, even though an effect of a configuration of the present disclosure is not explicitly described in describing the embodiment of the present disclosure above, it is obvious that the predictable effect from the configuration should be recognized.

What is claimed is:

1. A home appliance comprising:
a body having an inner space defined therein; and
a door configured to open and close the inner space, the door including: a
door frame located in front of the body; and
a door panel located in front of the door frame, the door panel including: a
panel body located in front of the door frame to cover the door frame;
a fitting protrusion fitted with the door frame to couple the panel body to the door frame, the fitting protrusion being displaced upwardly or downwardly relative to the door frame to prevent the panel body from moving forwardly or rearwardly relative to the door frame; and
a fastening protrusion coupled to the door frame to prevent the panel body from moving upwardly or downwardly relative to the door frame, the fastening protrusion being located below the fitting protrusion.

2. The home appliance of claim 1, wherein the door frame includes:
a panel support portion defining a front surface of the door frame; and
a top protrusion located in front of the panel support portion, the top protrusion being spaced from the panel support portion in a front-rear direction to define a fastening groove, and
wherein at least a portion of the fitting protrusion is inserted into the fastening groove.

3. The home appliance of claim 2, wherein the fitting protrusion includes: a
first protrusion portion protruding rearwardly from the panel body; and
a second protrusion portion protruding upwardly from the first protrusion portion,
the second protrusion portion being inserted into the fastening groove.

4. The home appliance of claim 3, wherein a top of the second protrusion portion protrudes upwardly beyond a top of the panel body.

5. The home appliance of claim 2, wherein the panel body is located in front of the fitting protrusion so as to cover the fitting protrusion.

6. The home appliance of claim 1, wherein the door frame includes:
a panel support portion defining a front surface of the door frame; and
a fitting hole extending through the panel support portion in a front-rear direction,
wherein the fitting protrusion includes:
a protrusion body protruding rearwardly from the panel body; and a
stopper portion protruding upwardly from the protrusion body,
wherein, when the door panel is moved rearward during assembly, the stopper portion is configured to pass through the panel support portion through the fitting hole, and
wherein, when the door panel is moved upwardly during assembly, at least a portion of the stopper portion is located higher than an uppermost extent of the fitting hole so as to face a rear surface of the panel support portion.

7. The home appliance of claim 6, wherein the fitting protrusion includes a recess at a connection portion between the protrusion body and the stopper portion, the recess having a shape in which at least one of a top surface of the protrusion body is downwardly depressed or a front surface of the stopper portion is rearwardly depressed.

8. The home appliance of claim 6, wherein the fitting protrusion has a curved portion connecting a rear surface of the stopper portion and a top surface of the stopper portion to each other.

9. The home appliance of claim 6, wherein the door panel further includes a rib protruding from the panel body, the rib being located between the panel body and the panel support portion, and
wherein the rib contacts the panel support portion when the door panel is coupled to the door frame.

10. The home appliance of claim 1, wherein the door frame includes:
a panel support portion defining a front surface of the door frame;
a top protrusion located in front of the panel support portion, the top protrusion being spaced from the panel support portion in a front-rear direction to define a fastening groove; and
a first fitting hole located between a lower end of the panel support portion and the top protrusion, the first fitting hole extending through the panel support portion in the front-rear direction, and
wherein the fitting protrusion includes:
a first fitting protrusion inserted into the fastening groove; and
a second fitting protrusion located between the first fitting protrusion and the fastening protrusion, the second fitting protrusion extending through the first fitting hole.

11. The home appliance of claim 10, wherein the door frame further includes a second fitting hole extending through the panel support portion in the rear-front direction,
wherein the second fitting protrusion includes a pair of second fitting protrusions spaced from each other horizontally, and
wherein the fitting protrusion further includes a third fitting protrusion located between the pair of second fitting protrusions, the third fitting protrusion extending through the second fitting hole.

12. The home appliance of claim 11, wherein the first fitting protrusion includes a plurality of first fitting protrusions spaced from each other horizontally,
wherein the third fitting protrusion includes a plurality of third fitting protrusions located between the pair of second fitting protrusions, and
wherein each of the third fitting protrusions is located between an adjacent pair of the first fitting protrusions.

13. The home appliance of claim 10, wherein the first fitting protrusion includes a plurality of first fitting protrusions spaced from each other horizontally, and
wherein one of the first fitting protrusions is located at a horizontal center of the door panel and has a length in the horizontal direction that is larger than a length in the horizontal direction of each of remaining ones of the plurality of first fitting protrusions located at positions other than the horizontal center of the door panel.

14. The home appliance of claim 13, wherein the door frame further includes a pair of second fitting holes extending through the panel support portion in the rear-front direction,
wherein the fitting protrusion further includes a pair of third fitting protrusions spaced from each other horizontally, the pair of third fitting protrusions being located between the first fitting protrusions and the fastening protrusion, the pair of third fitting protrusions extending through the pair of second fitting holes, and
wherein the one of the first fitting protrusions is located between the pair of third fitting protrusions.

15. The home appliance of claim 1, wherein the door frame includes:
a first fastening groove recessed rearwardly in a front surface of the door frame; and
a fastening boss located above the first fastening groove,
wherein the fastening protrusion is inserted into the first fastening groove so as to face the fastening boss in a vertical direction, and
wherein the home appliance further includes a fastener passing through the fastening protrusion and the fastening boss in the vertical direction to couple the fastening protrusion and the fastening boss to each other.

16. The home appliance of claim 15, wherein the door panel further includes a second fastening groove recessed upwardly in a bottom surface of the fastening protrusion, and
wherein the fastener includes:
a body passing through the fastening protrusion and the fastening boss; and
a head connected to the body and exposed below the fastening boss, the head being accommodated in the second fastening groove.

17. The home appliance of claim 1, wherein the door frame includes a fitting hole recessed rearwardly in a front surface of the door frame, and
wherein the fastening protrusion is received within the fitting hole.

18. The home appliance of claim 17, wherein a bottom surface of the door frame and the fastening protrusion face each other in the vertical direction, and
wherein the home appliance further includes a fastener passing through the fastening protrusion and the bottom surface of the door frame in the vertical direction to couple the door frame and the fastening protrusion to each other.

19. The home appliance of claim 18, wherein the door frame further includes:
a fastening groove recessed upwardly in the bottom surface of the door frame; and
a fastening boss located above the fastening groove,
wherein the fastener includes:
a body passing through the fastening protrusion and the fastening boss; and
a head connected to the body and exposed downwardly of the fastening boss,
wherein the head is accommodated in the fastening groove.

20. The home appliance of claim 19, further comprising a cap located below the head to cover the head, the cap being inserted into the fastening groove.
